(19) United States
(12) Patent Application Publication
(10) Pub. No.: US 2013/0090247 A1
(43) Pub. Date: Apr. 11, 2013

(54) METHODS AND SYSTEMS FOR IDENTIFICATION OF BINDING PHARMACOPHORES

(71) Applicant: Stephen Philip Gardner, Royston (GB)

(72) Inventor: Stephen Philip Gardner, Royston (GB)

(73) Assignee: Biolauncher Ltd., Cambridge (GB)

(21) Appl. No.: 13/271,000

(22) Filed: Oct. 11, 2011

(51) Int. Cl. C40B 20/00; C40B 60/06

(52) U.S. Cl. 506/2; 506/36

(57) ABSTRACT

The invention provides systems and methods for generating 3D binding consensus pharmacophores. Initially, peptide screening sequence data is aligned. For one or more positions of the alignment: an observed distance matrix describing a distance between the relative binding activity of pairwise comparisons of each amino acid at the selected position is constructed, the observed distance matrix is compared to a plurality of field-based amino acid substitution matrices having the same shape as the observed distance matrix, preferred amino acid substitution matrices are identified from the plurality of amino acid substitution matrices based on the comparison, and a plurality of characteristics for the selected position are identified using the preferred amino acid substitution matrices. Characteristics for a plurality of positions of the alignment are used to generate three-dimensional peptide structures that represent predicted binding conformations. Molecular field information for these structures is clustered to determine a consensus field pharmacophore.

### FIELD OF THE INVENTION

The invention relates to methods and system for identification of 3D binding pharmacophores, and more particularly to methods and systems for identification of 3D binding pharmacophores using the results of a peptide screen and a library of context-specific, molecular field-based amino acid substitution matrices.

### BACKGROUND OF THE INVENTION

The cost of bringing novel pharmaceuticals to the market has been increasing rapidly for the last few decades. The process involves large risks and has increasingly led to disappointments as potential blockbusters have been lost from pipelines across the industry due to late-stage toxicity and efficacy issues. The increased risk aversion of regulators and ever higher approval hurdles has made drug development increasingly uncertain and costly.

At the same time, the market exclusivity period has been shrinking rapidly, from over 5 years two decades ago to under 3 months currently. There are many reasons for the increase in “me-too” compounds, not least the prevalence of high-throughput screening (HTS) systems in drug discovery, which has proved limiting and costly. HTS provides molecular starting points for drug development where the potential drug scaffolds (“hits”) have already been envisioned and encapsulated in a corporate compound collection. These collections typically include only a few hundreds of thousands or millions of compounds, although there are probably about 10⁴⁰ distinct drug-like chemotypes. Because much of the available chemistry is very similar and has relatively few rotatable bonds, there is a significant degree of overlap between different companies' chemistry libraries. As new targets become available they are quickly screened by multiple companies, resulting in a number of similar new compounds coming to market within months of each other. This in turn reduces the return from those compounds and ultimately threatens the on-going R&D budget. These trends reduce the potential for the development of new medicines, which may in turn lead to a slowdown in the improvement of patient outcomes in key disease areas such as cancer, metabolic diseases such as heart failure, stroke and diabetes and diseases of aging such as Alzheimer's and Parkinson's.

As a consequence of the trends above, there exists a need for systems and methods for more effective and cost-efficient small molecule candidate discovery and development. Furthermore it would be advantageous to increase the amount of sampling in the chemical space during large scale peptide screening and to provide further advancement of peptide screening and small molecule candidate discovery. Other efficiencies and benefits can also be realized with improved systems and methods for investigation into drug targets, their binding partners, and drug molecules based thereupon.

### SUMMARY OF THE INVENTION

The invention solving these and other problems of conventional systems relates to systems and method for using a known binding peptide sequence distribution and a library of context-specific, molecular field-based amino acid substitution matrices to identify consensus binding pharmacophores for a binding target. In some implementations, a process for identifying a consensus binding pharmacophore includes alignment of sequences of binding (and in some implementations non-binding and partially binding) peptides from a peptide screen. In some implementations, a binding motif of binding sequences from peptide screen may be identified from screening sequences and aligned to serve as the alignment used in the process.

A position of the alignment is then selected. In some implementations, as the process iteratively cycles, all positions of an alignment may eventually be selected. In some implementations, only some positions may be selected.

A relative activity score for each of the 20 amino acids is calculated based on the observed population of that amino acid in the binding and/or non-binding peptide populations of the alignment at the selected sequence position. In some implementations, the amino acid relativity scores can be normalized and/or weighted.

An observed distance matrix is then calculated by pairwise comparison of the relative activity scores of each of the 20 amino acids with each of the others. The comparison may include generating a measure of the difference or similarity between the two relative activity scores of each amino acid (as described herein, in some instances these scores may have been normalized and/or weighted). This observed distance matrix is then compared against sub-matrices in a context-specific, molecular field-based amino acid substitution matrix library. In some implementations, the observed distances matrix may be compared against all of the sub-matrices in the library. In some implementations, the observed distance matrix may be compared against a subset of all of the sub-matrices in the library. The comparison of the observed distance matrix is performed against the sub-matrices because the sub-matrices will be of the same shape (likely 20×20) as the observed distance matrix.

A definable size set of the most similar matrices is selected as the matrices that most closely match the sequence distribution observed for that position in the peptide alignment. These selected matrices are the “preferred” matrices that most closely match the sequence distribution observed for the selected position in the peptide alignment. In some implementations, one or more thresholds may be set (e.g., by an administrator or intelligently selected in an automated fashion) so that sub-matrices that are as similar or more similar to the threshold may be considered “preferred.” The threshold may be set by numerical limit (e.g., similarity>0.96 or by categorical value (e.g., top 10 most similar sub-matrices).

The backbone conformation, sidechain conformation (the specific amino acid rotamer), charge and ionization state, and/or other characteristics of the amino acids present at the selected position of the alignment is determined from the preferred sub-matrices. Selections of the preferred sub-matrices for each position in the peptide alignment (or binding sub-motif) are determined by serial analysis of each position in turn. When a given preferred sub-matrix is selected (as it reflects the observed amino acid substitution potential variance most accurately), this information is used to look up (i.e., using the larger matrix from which it was derived) the various sequence, conformational, charge and others characteristics of the residue at the selected position and its local environment.

In some implementations (e.g., if amino acid scanning information is available), the number of preferred conformation variants that are reconstructed for a given position in the binding peptide sequence (or binding sub-motif thereof) may be varied to preferentially sample conformational space around residues that are thought to be involved directly in the binding of the peptide to the target. Whereas a single amino acid variant (consisting of a specific set of sequence, backbone conformation, sidechain conformation, charge and ionization state and other parameters), representing the parameters encoded by the most similar preferred matrix/sub-matrix combination may be sufficient to represent a ‘non-binding’ amino acid position, we may choose to include more variants at positions known to be involved in binding. This is because the ‘non-binding’ position are not forming direct interactions with the target protein and are therefore acting only to hold the larger peptide structure together and in the correct conformation. These positions can be considered to have minimal or no information content describing the impact on the strength and specificity of the binding interaction, and will therefore not contribute directly to the ultimate field pharmacophore for the binders.

The process may then selected another position on the selected peptide/motif alignment and the previous operations are iterated until all the peptide/motif sequence alignment has been analyzed (or a desired subset thereof).

A population of 3D peptide structures is generated using the identified sequence, backbone, rotamer, and charge and ionization state information at each position of the alignment. This may be done by sequentially generating peptides having every possible combination of sequence, backbone, rotamer, and charge and ionization state combinations. Conformations with steric clashes are detected and discarded or may be subject to a constrained energy minimization run. In this technique, the atoms of the molecule are moved in small directed increments away from areas of high energy interactions (i.e. steric clashes) into more acceptable positions. This simulates the relaxation of a molecule into a low energy state.

Molecular fields (and field points, when used) are then generated for each 3D peptide structure. This may include applying a force field program/field calculation tool that calculates the molecular electrostatic potential across the surface of the variant molecules. In some implementations, the force field module may create a contour map around a generated 3D molecular structure at a van der Waals radius distance for one or more of 4 fields ([1] the positive electrostatic field of the molecule's surface; [2] the negative electrostatic field of the molecule's surface; [3]: the steric (shape/stickiness) properties of the molecule's surface; and [4] hydrophobic properties of the molecule's surface in its bioactive conformation). An example of this type of force field/field calculation tool includes the XED™ force field tools offered by Cresset Biomolecular Disclovery Ltd (see also e.g., U.S. Pat. No. 7,805,257, which is hereby incorporated by reference herein in its entirety).

A consensus field pharmacophore may then be generated by aligning and clustering the resulting peptide structures' field information (e.g., whole fields or field points) in an operation known as ‘templating’. Templating allows the identification of consensus patterns of binding (pharmacophores) from amongst the generated peptide structures. This templating operation clusters the fields or field points associated with various molecules to identify the sets of fields or field points for all molecules that exhibit the minimum overall variation across the putative structures of the binding peptides. Field points that are closely conserved between the set of peptide structures are most likely to be those that are most directly involved in binding as these explain best the similarity between the molecules in terms of their likely biological activity and properties. These points will be incorporated into the consensus pharmacophore. If the fields of one or more molecules in a specific conformation cannot be matched to those of a larger series of other molecules that align amongst themselves, it is likely that those molecule/s exist in a different conformation, perhaps because they have a different binding mode (they are binding in a different position to the target).

This consensus pharmacophore may be used as input for a search for small molecule drug candidates being capable of presenting a similar pattern of field points under physiologically accessible conditions that match that of the generated consensus field pharmacophore.

In some implementations, a system for generating a consensus field pharmacophore may include a control application, one or more computing devices, at least one input device, one or more data stores, one or more interfacing components, and/or other elements. The features and functions for constructing context-specific molecular, field-based amino acid substitution matrices may be enabled by such a system.

In some implementations, the invention provides computer-readable media having computer executable instructions thereon, that when executed by one or more processors, cause the one or more processors to perform one or more of the features and functions described herein for generating a consensus field pharmacophore.

These and other objects, features, and advantages of the invention will be apparent through the detailed description and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of systems and operations used in improved drug discovery, according to various implementations of the invention.

FIG. 2A illustrates an example 3D molecular model of a peptide, according to various implementations of the invention.

FIG. 2B illustrates an example model of molecular fields of a peptide, according to various implementations of the invention.

FIG. 2C illustrates an example model of field points for a peptide, according to various implementations of the invention.

FIG. 3 illustrates an example of a process for generating context-specific, molecular field-based amino acid substitution matrices, according to various implementations of the invention.

FIG. 4 illustrates an example of a Ramachandran plot used according to various implementations of the invention.

FIG. 5 illustrates an example of a portion of a context-specific, molecular field based amino acid substitution matrix, according to various implementations of the invention.

FIG. 6A illustrates an example of a context-specific, molecular field based amino acid substitution matrix, according to various implementations of the invention.

FIG. 6B illustrates an example of a context-specific, molecular field based amino acid substitution matrix, according to various implementations of the invention.

FIG. 7 illustrates an example of a system for generating context-specific, molecular field-based amino acid substitution matrices, according to various implementations of the invention.

FIG. 8 illustrates an example of a process for using context-specific, molecular field-based amino acid substitution matrices for peptide binding screen enrichment, according to various implementations of the invention.

FIG. 9 illustrates an example of a system for using context-specific, molecular field-based amino acid substitution matrices for peptide binding screen enrichment, according to various implementations of the invention.

FIG. 10 illustrates an example of a table showing a rotamer library distribution, according to various implementations of the invention.

FIG. 11 illustrates an example of a partial context-specific, molecular field-based amino acid substitution matrix and partial sub-matrices, according to various implementations of the invention.

FIG. 12 illustrates an example of a chart having preferred amino acids for use with an enriched peptide binding screen, according to various implementations of the invention.

FIG. 13 illustrates an example of a process for consensus pharmacophore generation, according to various implementations of the invention.

FIG. 14 illustrates an example of a system for consensus pharmacophore generation, according to various implementations of the invention.

FIG. 15 illustrates an example of a graphical user interface for specifying certain characteristics of context-specific, molecular field-based amino acid substitution matrices, according to various implementations of the invention.

### DETAILED DESCRIPTION

In some implementations, the systems and methods described herein provide improved tools for analyzing and optimizing peptides in the drug discovery process. In some prior systems and methods, the similarity of two peptides is scored using an amino acid substitution matrix, which may be derived in a number of ways (e.g. using evolutionary sequence, physiochemical property, or even grid-based surface similarity). However, in these methods, the types of amino acids are typically considered as indivisible entities, i.e. an average value is given for the propensity of one amino acid to substitute for another in all situations. This is a gross simplification that produces inaccurate results when dealing with the detailed contexts of specific peptide binding interactions. It is known that different amino acids have different propensities to substitute for each other in different protein contexts. Some methods do exist for considering the gross environment (e.g., polar vs. non-polar) of the amino acids as a way of evaluating substitution potentials more accurately, but these methods typically consider very limited numbers of environments inside conserved protein families. This limits the utility of the resulting matrices to similar environments and sequences and does not allow for their use in unforeseen contexts. In addition, the substitution matrices are calculated in these prior methods using observed sequence variation across a series of aligned homologous proteins, rather than by direct measure and comparison of their detailed surface properties. This means that the resulting matrices are still describing the evolutionary potentials for sequence conservation within the selected homologous protein families, rather than using an objective measure of their surface properties and interaction potentials with other molecules as is required when working outside of the families from which the substitution matrices were generated. In the context of peptide screening where fitness is driven by binding affinity (a product of the peptide's surface properties' complementarity with that of the target protein), such a direct measure and comparison of the physical properties presented by a specific peptide is important.

The systems and methods described herein recognize and exploit the very large number of highly detailed contexts in which amino acids may find themselves, and the impact that these contexts have on the likelihood of their substitution by another amino acid. The likelihoods of substitution between one amino acid and another are evaluated by direct comparison of the various peptides' molecular fields and/or molecular field points (both of which provide an assessment of the surface properties of a given peptide in a given context).

Each amino acid in a peptide or protein exists in its own multidimensional context consisting of multiple variables such as, for example, sequence, backbone conformation, charge and ionization state, sidechain conformation, location within the peptide, and/or other variables. There are therefore trillions of unique contexts in which a given amino acid can exist. As molecular field properties are highly dependent on the environment in which they find themselves, each of those different contexts will likely produce different molecular field properties, even for the same peptide sequence. Within each of those contexts, each different amino acid has different propensities to be substituted for each of the other amino acids that might be possible in a similar environment. This means that a single amino acid substitution matrix does not represent sufficient information to accurately describe the substitution potential in all given amino acid contexts.

In the systems and methods described herein, a range of substitution potentials can be calculated in molecular field and/or field point space for each of the specific amino acid contexts. This knowledge can be used to construct a library of context-specific, molecular field-based amino acid substitution matrices. Each of these matrices provides a description of both the specific context in which it has been calculated as well as the detailed substitution potentials of the various amino acids (or rotamers thereof) in that context. To reduce the computational load, the calculation of matrices may be prioritized so as to describe well-populated contexts that are representative of available conformational, charge, ionization, and sequence spaces adopted by known peptide and protein structures and/or the preferences for those parameters observed in the output of one or more peptide screening experiments.

Furthermore, knowledge of a peptide's binding to a specific target in a peptide screen can be used along with the library of context-specific, molecular field-based amino acid substitution matrices in methods designed to drive the selection of an enriched peptide screening library as well as the prediction of the likely 3D structure of the binding conformation of binding peptides from that screen. In these contexts, matching observed sequence preferences at various positions of binding and non-binding peptides to one or more matrices from the library of context-specific, molecular field-based amino acid substitution matrices enables prediction of the likely sequence preferences and 3D structure at those positions. In short, the systems and methods provided herein enable prediction of the series of preferable environments at each position of binding peptides in their preferred binding conformation. This information may then be used to find the most compatible series of sequence and 3D structure attributes associated with that set of binding and non-binding peptides.

Accordingly, in some implementations, the invention provides systems and methods for generating a library of context-specific, molecular field-based amino acid substitution matrices. This library of amino acid substitution matrices may have a myriad of beneficial computational uses. For example, the library may be used in conjunction with peptide screening processes to, inter alia, reduce the time and/or cost to get from a novel target to validated small molecule lead candidates; increase the amount of sampling of chemical space performed during binding peptide screening processes; increase the degree of chemical innovation offered in new chemical entities; provide advantages in developing and securing intellectual property rights around the targeted activity/molecules (e.g., to sample all likely binding regions of chemical space, prevent fast-followers and create out-licensing opportunities); and/or to provide other improvements and advantages. Accordingly, the productivity and innovation potential of the whole biopharmaceutical discovery industry can be improved. In some implementations, a library of field based amino acid substitution matrices can be used in an automated production system to deliver a rapid, cheap and innovative drug discovery platform that can translate discoveries made in novel biological targets into validated chemical entities at the rate, cost and risk that is improved from current processes and systems.

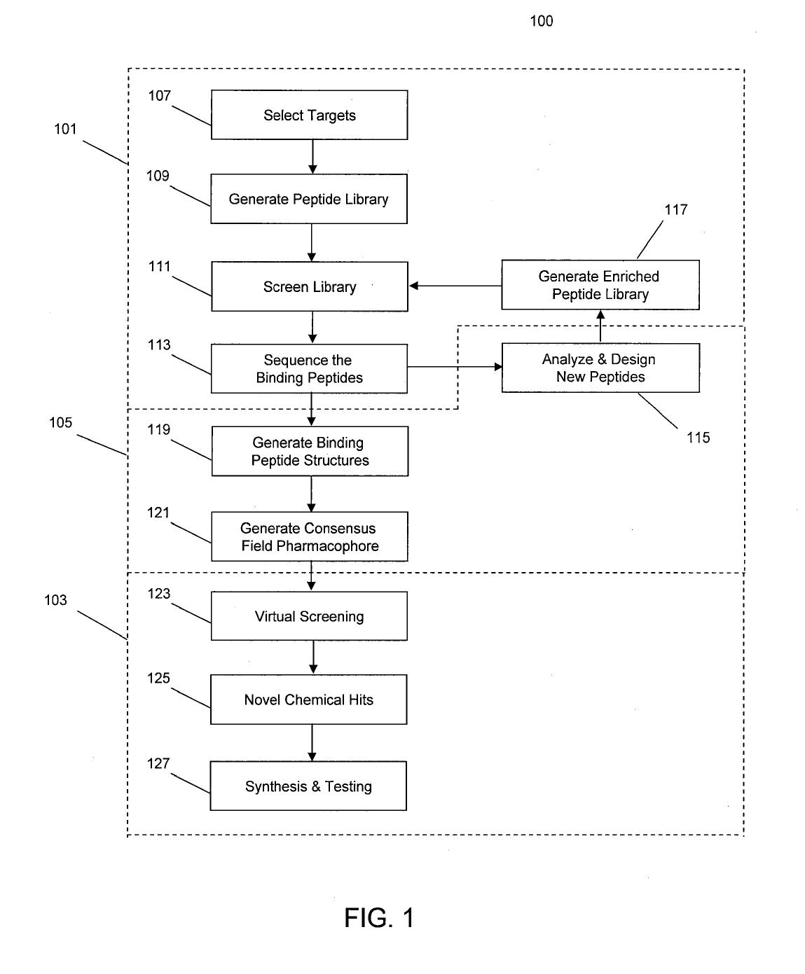

FIG. 1 illustrates a process 100, which is an example of a lead candidate drug discovery and development process. Process 100 includes peptide library screening processes and systems 101 and molecular field based small molecule discovery and development processes and systems 103. The context-specific, molecular field-based amino acid substitution matrices discussed herein can be used in structural bioinformatics processes and systems 105 that may interact with both peptide library screening processes/systems 101 and molecular-field-based small molecule discovery and development processes/systems 103. In some implementations, structural bioinformatics processes and systems 105 may be used to meaningfully and intelligently join the data generated by the processes and systems 101 and 103. In some implementations, these three components may provide a platform capable of moving rapidly and cost-effectively from new drug targets to novel candidate drugs. However, it is noted that each of these systems alone (including certain subsystems thereof) or sub-combinations thereof, may provide useful outputs for utilization in practical and investigative disciplines.

Peptide screening processes/systems 101 may enable the development and testing of libraries of randomly generated and/or targeted peptides. For example, in an operation 107, a target for lead candidate drug discovery development may be selected. The target may be a protein or other molecule that has or approximates at least one binding site to which at least some of the peptides in the screening library will bind. Presumably, the aforementioned binding has some effect or consequence when occurring in vivo. The selected target is the target against which a peptide library of potential binding peptides will be screened to see if the aforementioned desired binding occurs between any of the binding peptides of the library and the target. In some implementations, a plurality of targets may be selected and screened separately or simultaneously. In some implementations, a plurality of screens may be run on the same target, but under different conditions (e.g., to evaluate changes in binding affinities under the different conditions).

library of binding peptides may be generated in an operation 109. In one example, a library of binding peptides comprising 10¹³-10¹⁴ 16-mer peptides may be generated. In some instances, the length of peptides in a given library may be uniform across that library and may be specified as part of the library design. In some instances, peptide libraries may vary in length from 3-35 amino acids. Additional information relating to the design and performance of peptide library screening can be found in U.S. Pat. No. 7,416,847 and U.S. Pat. No. 7,842,476, the contents of each of which are hereby incorporated by reference herein in their entirety.

The library may then be screened against the selected target in an operation 111. In some instances, the screening may be done in a cell free system enabling intracellular, extracellular, and membrane-bound targets to be addressed. In some instances, the target molecule is immobilized on a substrate and the peptides of the library are introduced to the substrate under binding conditions. Other methods known to those having skill in the art may be used. Any number of detection methods (e.g., fluorescence, dye, voltage change across a membrane, resistance changes in an excited cantilever system, etc.) can be used to determine when peptides from the library bind to the immobilized target (the peptides that bind in the screen may be referred to as “binding peptides”). In some instances, all non-binding peptides are washed off and the remaining binders are eluted away from the substrate prior to further analysis.

In some instances, each of the peptides of the library is attached to its coding DNA sequence, enabling the amino acid sequence of each of the peptides (including those that bind, those that partially bind, and those that don't bind) to be easily determined. See also, U.S. Pat. No. 7,842,476, the contents of which is hereby incorporated by reference herein in its entirety.

Due to their inherent flexibility, the peptides in the library may sample a huge conformational space (potentially tens or hundreds of orders of magnitude greater than a standard high throughput screening (HTS) library). Standard HIS libraries contain 10⁵-10⁶ drug-like compounds, which are typically selected to be relatively inflexible small molecules that have fewer than 5-6 rotatable bonds and very few chiral (i.e., lacking mirror-image symmetry) centers. This makes the HTS library and compounds derived from it relatively easy to synthesize and test, but greatly restricts the chemical space sampling potential (and thus, the innovation potential) of the library. Peptides, on the other hand, are notoriously flexible, due to their relatively high numbers of rotatable bonds across both their backbones and their sidechains. Peptides also present a wide variety of chemical properties at their surface due to the huge combinatorial sequence possibilities. These attributes are very useful for screening, as the massive sampling potential of peptide screening libraries enable a much higher number of binding peptides to be identified. However, these attributes can become an obstacle when seeking to develop the peptides further into a therapeutic product. However, the systems and the methods provided herein enable intelligent and efficient identification of drug candidates in spite of these obstacles. A further advantage of peptide binding libraries is that they are typically faster and cheaper to screen than traditional HTS libraries.

Once the peptide screen has been run, the binding peptides are sequenced in an operation 113. As discussed herein, in some instances, this sequencing may be enabled by the fact that each of the peptides of the library may be attached to its DNA coding sequence, which facilitates determination of the amino acid sequence of the peptide (as DNA sequencing methods are robust, inexpensive, rapid, and reliable as compared to protein sequencing). In some instances, this coding DNA attachment may include use of CIS display technology offered by Isogenica Limited (see e.g., U.S. Pat. No. 7,842,476, the contents of which are hereby incorporated by reference herein in their entirety). In this case, the coding DNA sequence can readily be ligated and sequenced using one of a variety of known DNA sequencing techniques. The attachment of coding DNA to each peptide of a peptide library is adapted from a natural system in which a DNA binding protein (RepA) binds to the same template DNA from which it was derived. RepA binds to a site known as on but an element known as CIS is necessary for this activity. It is thought that CIS stalls the RNA polymerase and enables loading of the translated protein onto ori. By fusing peptide or protein libraries to RepA, the expressed peptide is attached to its coding DNA through attachment of RepA to ori. Therefore the sequence of the peptide can be determined directly by sequencing its encoding DNA. As this system is based on DNA rather than RNA, it is significantly more stable than RNA-based display systems (e.g. ribosome display). Accordingly, this attachment of coding DNA is an efficient selection methodology for large library sizes and thus enables isolation of peptides with higher binding affinity than other approaches.

The peptide screen may be run in iterative cycles, using structural bioinformatics processes/systems (e.g., processes/systems 105) such as, for example the structural bioinformatics processes/systems utilizing context-specific, molecular field-based amino acid substitution matrices described herein, to enrich each iterative cycle. These iterative cycles optimize sampling of the binding population and reduce the number of peptides in a screen from trillions to hundreds, which, as described herein, can then be clustered to create a binding pharmacophore for the target.

In the cycles of an iterative peptide screen, the previous population of binding peptides (and, in some instances, information from the peptides that don't bind or partially bind) may be used as a starting point for designing a peptide library for the next cycle. For example, in an operation 115, information regarding which peptides from the original library were observed to bind (and, in some instances, partially bind or not bind at all) may be used to formulate a new “enriched” peptide library for a subsequent screen. A library of context-specific, molecular field-based amino acid substitution matrices, as described herein, may be used to determine which modifications might be made to the population of known binding proteins so as to intelligently engineer the subsequent peptide library.

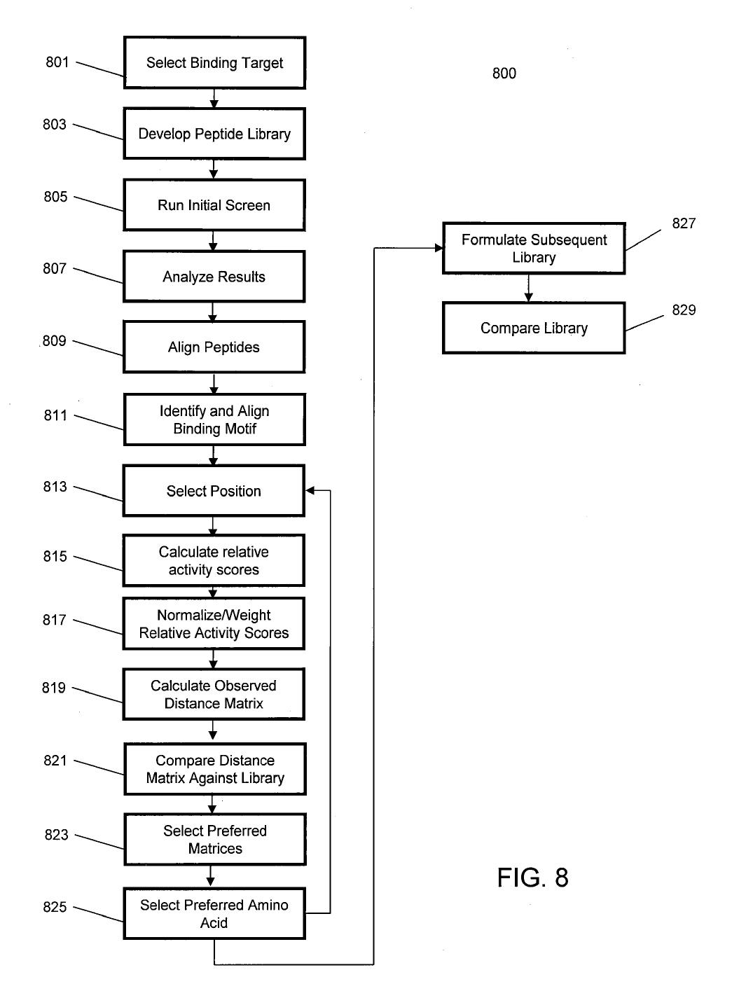

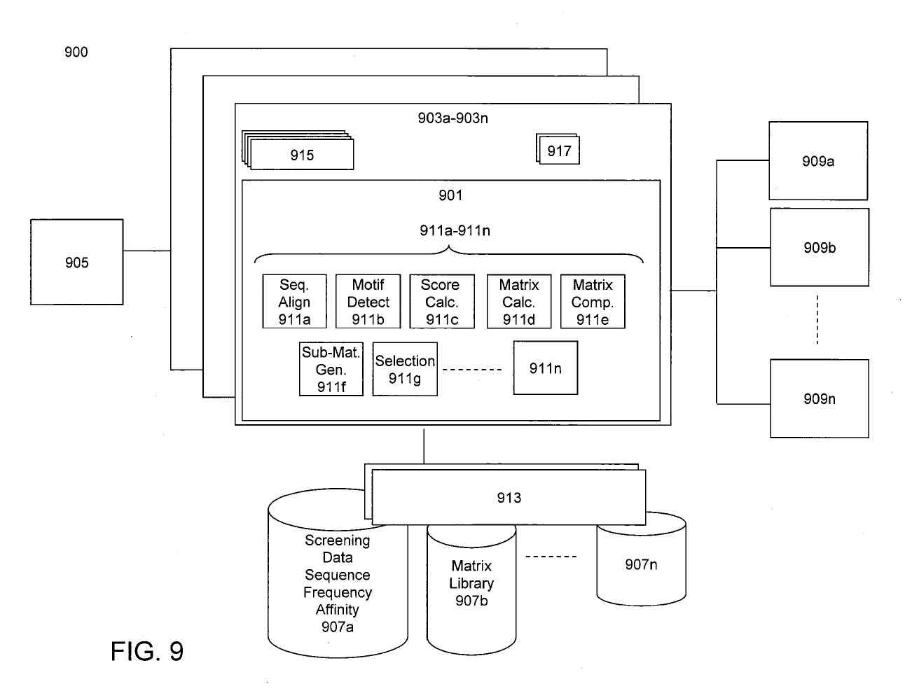

In an operation 117, the new library may be generated for the subsequent round in the iterative screen. The output of the iterative peptide screen may be a set of binding peptide sequences, each with its respective frequency count (indicating the frequency of its binding to the target out of a maximum number of potential binding instances) and/or other indicators of binding affinity to the target. In some instances, iterative screening may be run for a predetermined number of cycles. In some instances, the screen may be run until the identified binding peptides from a given round meet certain criteria. Further discussion of the use of context-specific field-based amino acid substitution matrices in conjunction with an optimized iterative peptide screen can be found herein (see e.g., FIGS. 8 and 9 and related description).

As described herein, systems and methods described herein may utilize a library of context-specific, molecular field-based amino acid substitution matrices to generate a population of 3D structures of peptides (in their bioactive conformations) for the sequences of binding peptides identified from peptide screening (e.g., in an operation 119). From these 3D structures, a consensus field pharmacophore (a molecular framework that describes the essential features responsible for a molecule's biological activity) may be constructed from a population of binding peptides (e.g., in an operation 121). A consensus field pharmacophore may be considered a consensus version of the molecular fields and/or field points from a series of molecules that are known to bind at the same target, keeping molecular fields/field points that are common between the molecules and eliminating those that vary (as they are not essential for or may be deleterious to binding). Such selection of field points may be informed by the relative binding affinities of the various binding and non/partially-binding peptides.

Molecular field and/or field point representations provided by processes/systems 103 may then be used to identify small drug-like molecules that are peptidomimetics (i.e., peptide mimicking) for the population of binding peptides. For example, field technology provided by Cresset Bimolecular Discovery Ltd enables representation and comparison of the biological activity and properties of molecules. See, for example, U.S. Pat. No. 7,805,257, the contents of which are hereby incorporated by reference herein in its entirety. Rather than simple two dimensional (2D) structure similarity, field based methods use the complex, three dimensional (3D) surface properties around molecules to assess their likely activity and properties. In some implementations, four molecular fields may be used to describe the surface properties of a molecule that contribute to binding: 1) the positive electrostatic field of the molecule's surface; 2) the negative electrostatic field of the molecule's surface; 3): the steric (shape and stickiness) properties of the molecule's surface; and 4) the hydrophobic properties of the molecule's surface in its bioactive conformation. These are important contributors to molecular interactions between drugs and their protein targets. In some implementations, more or less than the 4 above-identified molecular fields may be used. Field-based systems and methods uniquely identify important regions on the fields (the maxima, where the potential for interactions with another molecule are strongest) and substitute those portions of the field surface with field points to make for tractable computation.

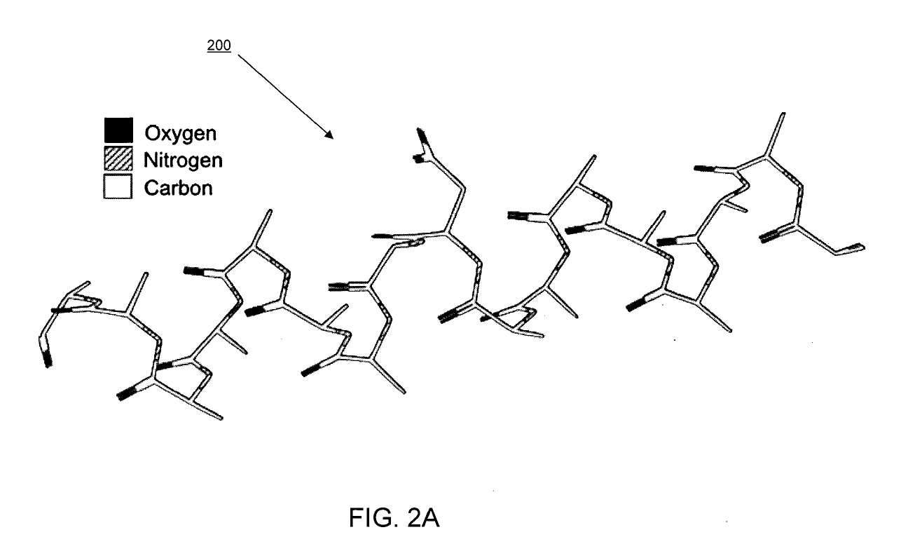

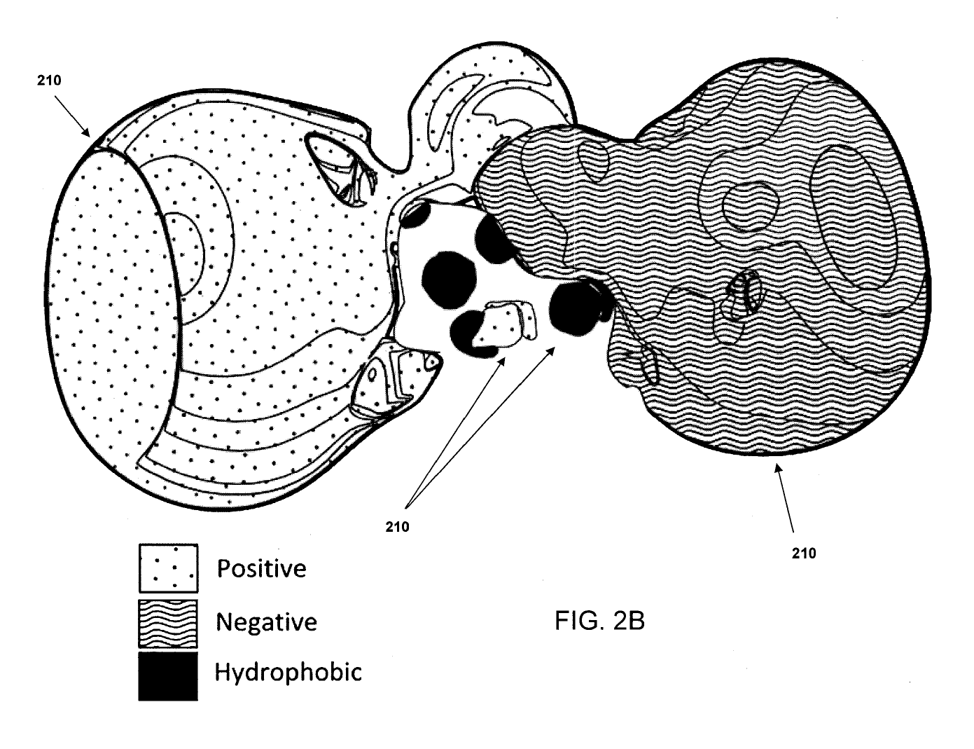

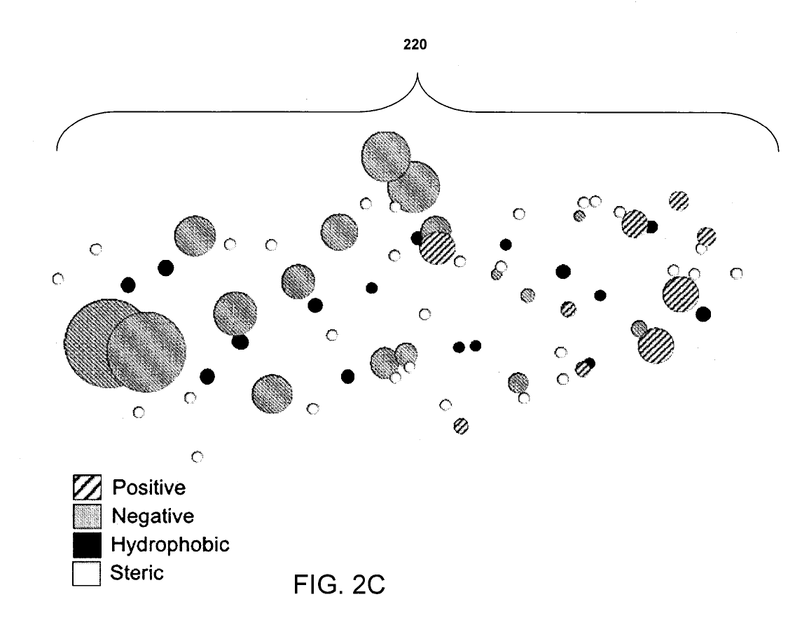

FIGS. 2A-2C illustrate the concept of molecular fields and field points. FIG. 2A illustrates a 3D molecular structure of a peptide molecule 200, including the bonds and constituent parts of the peptide. In FIG. 2A, the positions of the atoms in molecule 200 are represented at the vertices of the lines, while the bonds between atoms are represented by the connecting lines. The bond order (single or double bonds) is represented by one or two parallel lines. The type of atom is represented by color, with carbon (C) atoms shown in solid white, nitrogen (N) in diagonal hashes, and oxygen (O) in solid black. For the sake of clarity, the hydrogen atoms that are present on the molecule are not shown.

FIG. 2B illustrates the calculated field characteristics 210 of molecule 200. FIG. 2B, illustrates surfaces that have been drawn over the molecule (molecule 200 of FIG. 2A) and that represent the extent of each of the molecular fields as measured at a given field strength threshold. In this case, a field strength threshold of 3.0 was used. As described in the key, the wavy lined surface represents the extent of the negative electrostatic field, and the polka-dotted surface represents the positive electrostatic field. A solid white field (not visible in FIG. 2B) represents the steric field and the solid black field represents a hydrophobicity field. In this case, the strong positive-negative field distribution (negative at one end and positive at the other) reflects the dipole moment associated with an alpha helical peptide structure.

FIG. 2C illustrates the field points 220 of molecule 200, which are derived from the calculated field characteristics 210. In this figure, a heavy right to left diagonal hashing represents the positive field points, and the close left to right diagonal hashing represents the negative field points. Hydrophobic field points are represented in solid black and steric field points in solid white. Field points 220 are indicators of the extrema of the whole molecular field characteristics 210. In FIG. 2C, each of the whole field surfaces of FIG. 2B has been substituted by one or more field points. To generate these field points, the maxima of the field surfaces are calculated and field points of the appropriate type and size (proportional to the scale of the field value at the extrema—thus leading to the variation in the size of the points illustrated in FIG. 2C) are introduced at the locations of the extrema. In some implementations, the use of field points rather than whole fields may be useful due to the fact that field points are more computationally tractable than whole fields (which represent a whole 3D surface across a molecule and which may consequently include considerable information that is irrelevant to the determination of binding interactions). Determining field points 220 at the extrema of whole fields 210 may be more expressive of the characteristics that define the activity of a molecule than would be a sampling of field characteristics 210 across a regular geometric or volumetric grid. However, the use of sampling field characteristics across regular geometric or volumetric grids may be used. In some instances, the calculation of the molecular fields from which field points are subsequently calculated, may use a force field (i.e., a set of parameters and equations for use in determining the potential energy of a system of molecules and their constituent atoms) that places and simulates the interactions of the electrons of atoms at their correct van der Waals radius, rather than at the center of the atom, which may provide more accurate field and field point calculations. An example of this type of force field tool includes the XED™ force field tools offered by Cresset Biomolecular Discovery Ltd (see also e.g., U.S. Pat. No. 7,805,257, which is hereby incorporated by reference herein in its entirety).

Any molecule, regardless of its atomic composition and structure, that can present the same field point pattern is likely to have similar biological activity and properties. Comparison of field points can therefore identify molecules that are likely to bind to and be active at the same target as an identified consensus binding peptide, even when they are structurally divergent. Field-based technology is therefore suited for finding small drug-like peptidomimetic molecules that have equivalent biological activity to an identified consensus binding peptide.

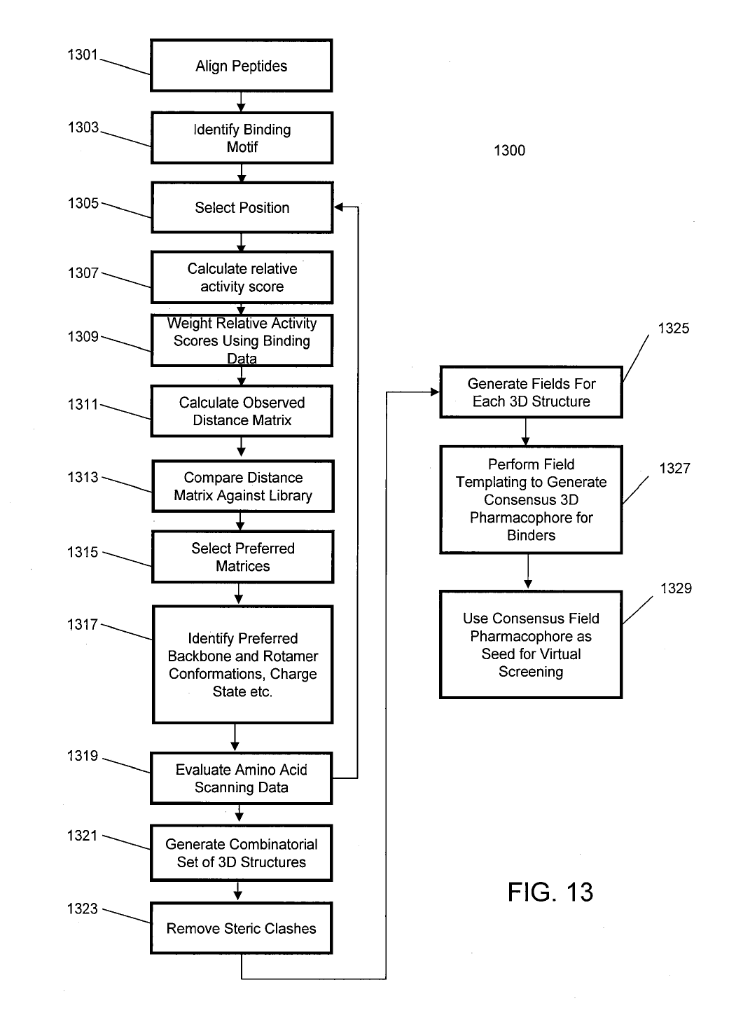

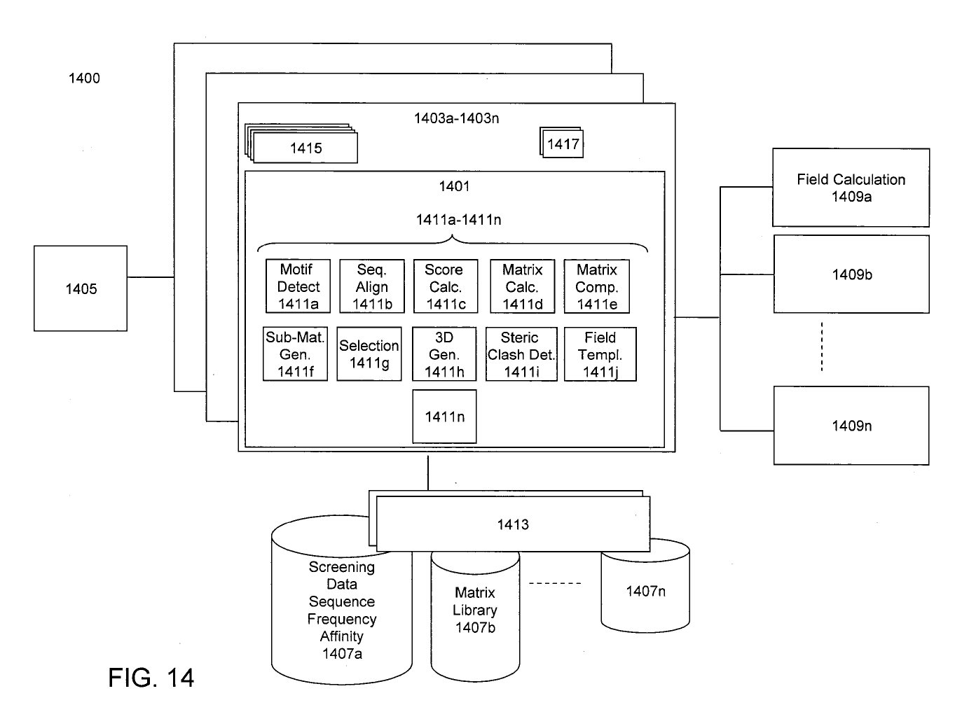

Returning to FIG. 1, the consensus field pharmacophore identified in operation 121 represents what a protein target ‘sees’ of the binding peptide. This pattern contains no information about the structure (bonds and angles) that generated it and many different molecules could potentially generate a similar pattern. It has repeatedly been demonstrated that any molecule that can present a sufficiently similar configuration of field points will have the same or similar activity (subject to being able to adequately penetrate the target's binding pocket). Thus, field-based systems reduce the dependency on two dimensional (2D) structural similarity and can be used to accurately predict active peptidomimetics. This may result in multiple, structurally diverse drug-like small molecules that have the same target specific biological effects as the identified binding peptides. However, identifying these small molecule peptidomimetics may require an accurate model to be built of the three-dimensional (3D) structure that binding peptides actually adopt in their binding conformation. Generation of a field pharmacophore using a library of context-specific field-based amino acid substitution matrices is discussed further herein (see e.g., FIGS. 13 and 14 and related description).

Field-based systems/processes 103 may include operations such as, for example, a virtual screening operation 123, wherein small molecule drug candidates matching the determined consensus field pharmacophore are virtually screened. In an operation 125, novel chemical hits (small molecules resulting from the virtual screen) that match the consensus field pharmacophore are identified. In an operation 127, the identified chemicals are purchased, synthesized, and/or otherwise obtained, and tested as drug candidates.

The structural bioinformatics systems and methods provided and enabled by the library of context-specific, molecular field-based amino acid substitution matrices described herein may fill a gap between peptide screening and peptidomimetic identification systems and methods as well as providing other uses. This library of substitution matrices may enable improved peptide screening as well as discovery of three dimensional (3D) structures of the bioactive binding conformation and consensus field pharmacophores from a population of screened binding peptide sequences. These 3D consensus field pharmacophores can be used as the basis of a small molecule virtual screening search.

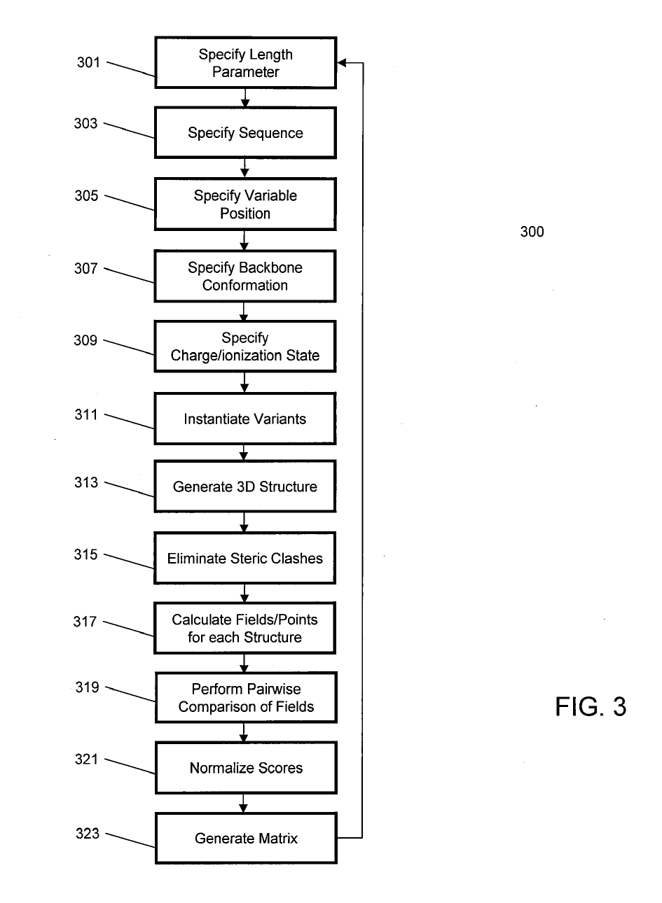

In some implementations, the invention provides methods and systems for generating a library of context-specific, molecular field-based amino acid substitution matrices based on molecular fields and/or molecular field points of peptides. FIG. 3 illustrates a process 300, which is an example of a process for constructing a context-specific, molecular field-based amino acid substitution matrix according to various implementations of the invention. Numerous context-specific, molecular field-based amino acid substitution matrices may be produced, by using process 300 (or similar processes according to the description provided herein) numerous times. A plurality of these context-specific, molecular field-based substitution matrices can be assembled or used as a library of substitution matrices.

Construction of a context-specific, molecular field-based amino acid substitution matrix includes selecting one or more peptide characteristics to be held static, while creating peptide variants that substitute different amino acids and/or rotamer variants thereof into one or more positions of the otherwise static peptide. In this manner, it can be determined what effect each such substitution has on the peptide. The use of molecular fields (or field points) as described herein, provides a relevant measurement from which to measure the effect of such substitutions. The field measurements/calculations enable comparison of each different substitution with each other different substitution. As described herein, molecular fields (and field points) provide a description of the surface properties of a peptide and therefore the comparison of field data of different peptide variants provides a similarity and/or dissimilarity score describing the similarity between the binding properties of those individual peptide variants.

Each of the static characteristics (e.g., length, peptide sequence, backbone conformation, sidechain conformation, charge and ionization state, or other characteristic) can be considered a manipulable dimension for a library of context-specific amino acid substitution matrices. One or more of these characteristics may be varied for the construction of different amino acid substitution matrices that represent the binding potentials of variants across one or more of these dimensions. The specific combination of these characteristics provides the context for each amino acid substitution matrix, which is why it is referred to as a context-specific substitution matrix.

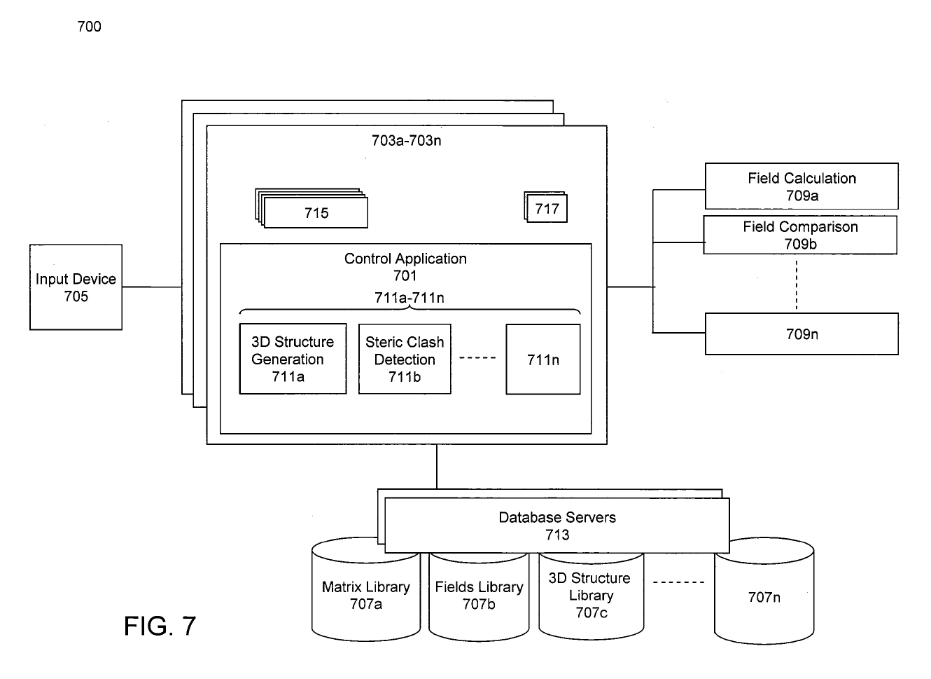

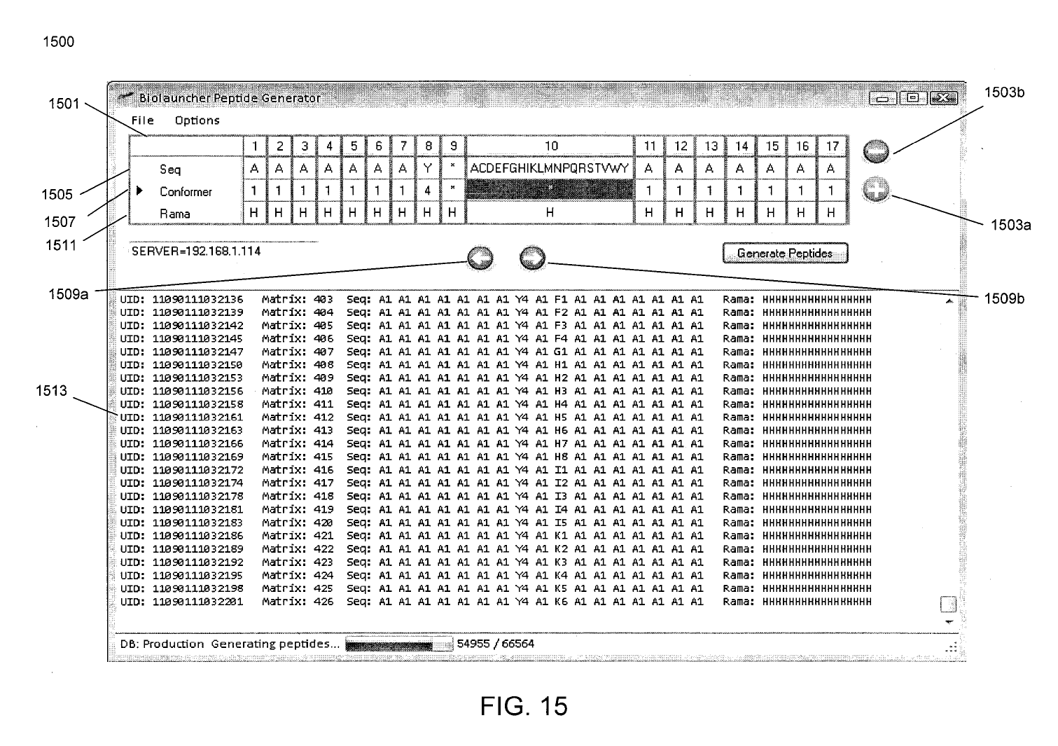

Process 300 includes an operation 301, wherein a peptide length parameter is selected or otherwise received into a computer system (e.g., by an interface supported by one or more modules 711a-711n or other portion of system 700 of FIG. 7) for constructing an amino acid substitution matrix. In some implementations, this may include an operator/investigator selecting or inputting (e.g., as a command line parameter) into a graphical user interface of the computer system, a specified number of amino acid residues (also referred to herein as “residues” or “amino acids”). FIG. 15 illustrates an interface 1500, which is an example of a graphical user interface for providing this information (the interface may be provided/supported by e.g., one or more modules 711a-711n or other portion of system 700). Interface 1500 may include a box or other element 1501 which displays characteristics of a peptide for which a matrix is being constructed. Note that, as illustrated, box 1501 illustrates a peptide length of 17 residues. Interface 1500 may also include buttons or other input elements 1503a and 1503b that enable the addition (i.e., via button 1503a) or subtraction (i.e., via button 1503b) of residues from the peptide.

The peptide length parameter specifies the number of amino acid residues for the peptides that will be used to construct the matrix. These peptides will have a number of “positions” equal to the number of amino acid residues specified by the peptide length parameter. In some implementations, each position is identified with a number corresponding to the peptides' length holding one end (the N-terminus) as position 1 (i.e., a 10-mer will have positions 1 through 10).

A matrix resulting from process 300 will provide amino acid substitution/distance values for a peptide having the length parameter specified/received in operation 301. In some implementations, the length parameter may be based on information regarding what peptide lengths are best fit for a given project, peptide screening library run, binding target, etc. In some implementations, these or other considerations may be used by one or more computer-implemented modules (e.g., portions of system 700) to determine the peptide length parameter. In some implementations, peptide length may be selected or otherwise received.

It should be noted that there is a difference between the specified sequence length used to construct a matrix and the length of peptides used in a screening library run. For example, if a screening library used 17-mer peptides (i.e., peptides having 17 amino acid residues), the length of a context-specific field based amino acid substitution matrix need not be 17. If it is found, for example, that a 9-mer is the longest useful window across which meaningful variations in the fields at a single amino acid position occur, then a length of 9 may be used as a length characteristic for calculating a matrix for use as described herein. In practical use, molecular field variations for variants of a specific 9-mer sequence may be calculated in different positions within a longer (e.g., 17-mer or other length) peptide to test the variability of its fields at different positions of the longer peptide. This is computationally less burdensome than calculating all possible 17-mer sequences.

In an operation 303, a reference amino acid sequence may be selected. Again, this sequence may be input by an operator/investigator into a graphical user interface (e.g., as a command line parameter) or otherwise received into a computer system (e.g., by an interface supported by one or more modules 711a-711n or other portion of system 700) for constructing an amino acid substitution matrix. Interface 1500 of FIG. 1500 illustrates an example of such a graphical user interface. For example, element 1501 of interface 1500 may include sequence row 1505, which may include a field or for each residue of the peptide for which a matrix is to be constructed. An operator may input one or more amino acids into each field at each position (except for one or more variable positions, see discussion below) for the peptide. For example position 10 in box 1501 has all 20 naturally occurring amino acids specified. Where more than one amino acid has been inputted at one or more positions all sequence combinations consisting of unique combinations of the specified amino acids will be permuted based on a combinatorial expansion of the amino acid sequences. Each of these permutations will yield a unique peptide that will form a unique context for the variable position specified. Accordingly, specifying more than one amino acid for a non-variable position in the peptide sequence, indicates that a different matrix will be generated for each different specified amino acid.

Note that interface 1500 illustrates single letters to indicate the identity of the amino acid specified for each position. In some implementations, these single letter designations may be the single letter amino acid naming convention that is generally recognized by those having skill in the art. Other naming conventions may be used, as desired.

In some implementations, another row of element 1501 may provide a field for each position of the peptide (except for variable positions) wherein one or more rotamers (otherwise referred to as “conformers” or “rotamer conformations”) of the entered amino acid can be specified (see e.g., conformer row 1507). In this manner, the different rotamers for amino acids of the specified sequence can be specified. The numbers specified in conformer row 1507 indicate a specific rotamer for the amino acid specified for that position. In some instances, some ammo acids may only have a single rotamer conformation (this may depend on the rotamer library used). Others may have multiple rotamer conformations (see e.g., position 8, wherein a number 4 rotamer conformation of tyrosine is specified). Where more than one rotamer has been specified at one or more positions, all rotamer combinations consisting of unique combinations of rotamers of the specified amino acids will be permuted based on a combinatorial expansion of the amino acid rotamers. Each of these permutations will yield a unique peptide that will form a unique context for the variable position specified. As discussed above with respect to specifying multiple amino acids for a non-variable position, specifying multiple rotamers for a single non-variable position leads to generation of an individual matrix for each specified rotamer.

In some implementations, the amino acids used (or available for inclusion) in the selected sequence may be selected from the 20 naturally occurring amino acids (i.e., ala, arg, asn, asp, cys, gln, glu, gly, his, ile, leu, lys, met, phe, pro, ser, thr, trp, tyr, val). However, in some implementations, the amino acids used (or available for inclusion in) in the selected sequence may be selected from a group including non-naturally-occurring and/or modified amino acids. In some implementations, selection of the sequence may be constrained to groups having fewer than the 20 naturally occurring amino acids. In some implementations, the selected sequence may include a specified amino acid or rotamer thereof at each amino acid position other than a variable position. In some implementations, the selected sequence may include a specific amino acid selection for each position and a variable position may be selected therefrom later.

In an operation 305, one or more variable positions may be selected for the sequence. While selection of a variable sequence is discussed after specifying of the reference sequence of the peptide (i.e., in operation 303), in some implementations, selection of the variable sequence may occur prior to specification of the reference sequence or concurrently therewith. The variable position may be input by an operator/investigator into a graphical user interface (e.g., as a command line parameter) or otherwise received into a computer system (e.g., by an interface supported by one or more modules 711a-711n or other portion of system 700) for constructing an amino acid substitution matrix. Interface 1500 of FIG. 1500 illustrates an example of such a graphical user interface, wherein position 9 is selected as a variable position. Box 1501 illustrates that position 9 has a “*” character specified in its corresponding sequence and conformer fields, indicating that the sequence and rotamers will vary at this point. In some implementations, interface 1500 may include arrows 1509a and 1509b or other elements enabling selection of a variable position. For example, arrow 1509a may be used to move the variable position (and specified surrounding sequences) towards position 1 and arrow 1509b may be used to move the variable position (and specified surrounding sequences) towards position 17. Other methods of selecting a variable position may be used. In some implementations, intelligent selection of the amino acid position of the variable position may include a module or other computer implemented element (see e.g., one or more modules 711a-711n or other portions of system 700) selecting a variable position based on one or more pieces of information/influences.

The variable position is the position in the peptide at which the amino acid sequence is varied while the remainder of the peptide characteristics/parameters (length, sequence, backbone conformation, sidechain conformation, charge and ionization state, and/or other characteristic) remain constant. As discussed herein, the molecular fields and/or field points for the peptide will be sampled for each of the variations and a matrix of substitution values is constructed based on a series of pairwise comparisons of these variations.

It is noted that developing a context-specific amino acid similarity matrix that is based on differences in field space can be a complex and computationally demanding undertaking. Molecular fields and therefore field points are highly dependent on the local environment of molecule. In the context of individual amino acids in a peptide, there are a number of factors that may have a significant impact on each amino acid's molecular fields. These factors may include: the surrounding amino acid sequence of the peptide in the immediate vicinity of the amino acid, the amino acid's position within the peptide, the peptide's backbone conformation (i.e., secondary structure), the charge and ionization state of the amino acid, the charge and ionization state of the amino acid's neighbors, the sidechain conformation of the amino acid, the sidechain conformations of its neighbors, and/or other factors. As described herein, some or all of these considerations may be used as characteristics defining the context of individual matrices, such that the resultant library of matrices has numerous dimensions based on these characteristics/variables. However, the number of theoretically possible combinations of these factors is astronomically large. For example, a sequence window of just ±5 amino acid residues around a central amino acid yields 20¹¹ (˜2×10¹⁴) unique sequences, each of which can exist in a huge range of backbone and sidechain conformations and charge states. Accordingly, using a brute force approach to build an amino acid similarity matrix (much less a library of substitution matrices), may present an intractable computational challenge. The problem space can therefore be reduced. While the resolution of the library of substitution matrices can be continually improved, reduction of the problem space at start is helpful. The systems and methods described herein are able to do this by a variety of methods.

Initially, it is noted that selection of the variable position in operation 305 may include intelligent selection. With reduction of the computational space in mind, it is noted that matrices need not (at least in the initial stages) be constructed for variations of all possible positions of a given peptide. Accordingly, intelligent selection of the variable sequence position(s) may include positions thought likely to have the greatest effect on the fields of the resultant peptide. This might depend on the sequence, the backbone conformation (secondary structure) hydrogen bonding patterns, and/or other factors. As discussed herein, selection of the variable position need not occur in the order provided in process 300, but may vary in order relative to selection of other characteristics described herein. In an example, for a peptide having a given sequence length, it may be decided that a predetermined number of matrices will be generated and that among those predetermined number of matrices, the variable position will vary among a predetermined number of positions (e.g., that make the most sense given the other characteristics of the peptide). For example, rather than sampling all 15 possible positions of a 3-mer sequence motif in a 17-mer peptide, the specific sequence motif including one or more variable positions may be placed at the C-terminus position, the N-terminus position, the central residue position, and/or, 2-4 other positions spaced along a peptide for construction of a given set of matrices.

As discussed herein, a single context-specific, molecular field-based amino acid substitution matrix may be only a part of a greater library of such matrices that are used for various purposes. This library may be constructed according to a strategy, so as to generate matrices that provide the most useful information for a given purpose. Accordingly, in some implementations, the creation of a single matrix may be part of a library creation strategy for the creation of multiple matrices that are similar, but which may vary intelligently at one or more of their characteristics. For example, it may be decided that a certain sequence motif of WP*PW (wherein W=tryptophan, P=proline, and *=the variable position) inside a peptide of specified sequence length of 17 (i.e., a 17-mer), may be desirable, according to a given library construction strategy. The motif may be of particular interest when investigating binding to a particular target. This motif may be located within the 17-mer according to 13 possible permutations. For practical reasons, only the following 5 sequence permutations may be sampled (wherein A=alanine):
WP*PWAAAAAAAAAAAA
AAAWP*PWAAAAAAAAA
AAAAAAWP*PWAAAAAA
AAAAAAAAAWP*PWAAA
AAAAAAAAAAAAWP*PW
   In the context of process 300, each of these different permutations represents a different set of sequence parameters and variable position parameters for individual matrices. In some implementations, for each of the above 5 sequence permutations, all of the different rotamer conformations (or the conformations selected from a predetermined set) for all of the different amino acids (or from a predetermined set) are substituted into the position “*” so as to generate variants used to construct the 5 individual matrices as discussed herein Thus, if the other characteristics are held constant among the 5 different sequence and variable position permutations, 5 matrices are produced, one for each of the sequence permutations.

Another example of a characteristic of a context-specific, field-based amino acid substitution matrix (and a potential dimension for a library of matrices) is the backbone conformation (which can also be referred to in some circumstances as the “secondary structure”) of the peptide used to construct individual matrices. While this is an important variable/parameter for several reasons (e.g., its effect on the other variables/dimensions), generating matrices for all theoretically possible backbone conformations presents a computational difficulty. Accordingly, intelligent consideration of a peptide's preferred backbone conformational space can be used in the selection of matrix variables.

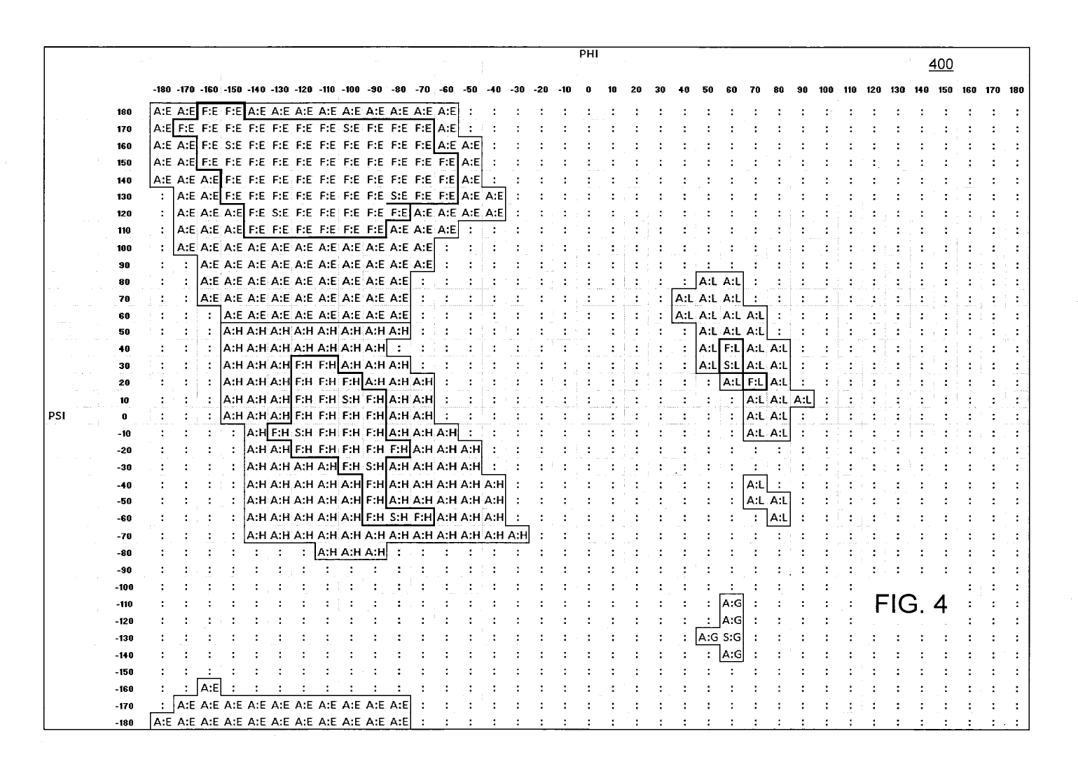

There are 3 backbone torsion angles that define peptide backbone conformation: phi (Φ), psi (Ψ) and omega (Ω). Each of the 20 naturally-occurring amino acids displays a preference for the backbone conformations that it will readily adopt. For a given residue, phi and psi angles can be plotted on a Ramachandran plot, and the “allowed” and “disallowed” regions of phi and psi space for the residue can be identified. FIG. 4 illustrates an example of a Ramachandran plot 400, showing allowed regions and disallowed regions. Each “allowed” region corresponds to a different secondary structure. There are 5 main secondary structural states (with a number of additional special cases): alpha helix (α); 3/10 helix; pi helix (π); lefthanded alpha (Lα); beta sheet (β); and special regions for glycine and proline (which have different constraints/preferences than other amino acids). Each secondary structural state can be represented in an idealized fashion by a combination of the preferred phi, psi, and omega backbone torsion angles as shown on a Ramachandran plot for a given amino acid. In some implementations, all amino acids can be reasonably expected to have Ω=180° (trans) except proline which may also exist in cis form)(Ω=0°. Taken together these simplifications can reduce the number of backbone conformations significantly—from 4.6×10⁷ if the 3 backbone torsion angles were permuted in 1° increments (360³) to a greatly reduced number (e.g., between 5 and 20) of preferred conformations.

Accordingly, in an operation 307, the backbone conformation of each amino acid for the selected peptide reference sequence may be specified for construction of the matrix. In some implementations, selection may be input by an operator/investigator into a graphical user interface (e.g., as a command line parameter) or otherwise received into a computer system (e.g., by an interface supported by one or more modules 711a-711n or other portion of system 700) for constructing a context-specific, molecular field-based amino acid substitution matrix. For example, element 1501 of interface 1500 may include backbone conformation row 1511 (also labeled “Rama”), which may include a field or for each residue of the peptide for which a matrix is to be constructed. An operator may input one or more backbone conformations (e.g., a-helical, β-sheet, etc.), into each field at each position for the peptide (the “H” illustrated in the positions of the sequence columns indicates that a-helix has been specified for the backbone conformation for each sequence position). Where more than one backbone conformation has been specified at one or more positions all backbone conformation combinations consisting of unique combinations of backbone conformations of the specified amino acids will be permuted based on a combinatorial expansion of the amino acid backbone conformations. Each of these permutations will yield a unique peptide that will form a unique context for the variable position specified. As discussed above with respect to specifying multiple amino acids and rotamers/conformers for a single non-variable position, specifying multiple backbone conformations for a single non-variable position leads to generation of an individual matrix for each specified backbone conformation.

In some implementations, additional rules based on known protein structure constraints may be applied to further reduce the number of permutations considered. For example, secondary structural elements typically have a minimum length (for example an alpha helix is described by consecutive hydrogen bonds formed between amino acids that are four residues apart in the sequence. This means that a motif consisting of 5 sequential amino acids respectively in α-helical, β-sheet, α-helical, β-sheet and α-helical conformations is very unlikely to exist and that combination of secondary structural states can therefore be ignored. In some implementations, the backbone conformation may be intelligently selected from among a set of allowed conformations as indicated by a Ramachandran plot for the specified sequence. In some cases, canonical backbone conformations that represent idealized forms of common secondary structural states can be used to sample the most likely backbone conformations that a peptide could adopt. In the construction of other matrices (which may share the same or similar specified sequence), other backbone conformations may be used.

FIG. 4 illustrates a graph 400 which is an example of a graph showing the preferred phi/psi angles that all naturally occurring amino acids adopt on a Ramachandran plot. The data behind this plot were generated by analysis of hundreds of high-resolution X-ray crystal structures of proteins from various families, after eliminating residues showing high B values. The outlined regions illustrate clusters (preferred regions) of phi/psi values that amino acids in proteins “prefer” to adopt. Top left region is beta, mid bottom left is alpha, top right is L-alpha, and bottom right is a special glycine region. The proline region is within the beta region and the 3/10 helix and pi helix regions are within the alpha region, so these are not shown separately. The outer regions (starting with “A:”) are the allowed regions, which constitute the broadest definition of an acceptable range. The regions starting with “F:” are the core “fully allowed” regions that represent the canonical states amino acids are found in. The regions starting with “S:”, are one possible set of sampling points. These sampling points may be used to reduce the total number of backbone conformations that are sampled so as to reduce the computational load. In this instance 10 sampling points were used. Regions labeled “:” are “disallowed” or “non-preferred” regions.

In some implementations, in an operation 309, the charge and ionization state for each residue of the reference peptide may be specified. In some implementations, a computer system (see e.g., FIG. 7) for constructing a context-specific, field-based amino acid substitution matrix may include a set of rules (e.g., in modules 711a-711n or other portion of system 700) for choosing a charge and ionization state for each specified amino acid. In this manner, the different charge and ionization states may be thought of as separate conformers for a given amino acid (and therefore may be considered a different rotamer in a rotamer library of amino acids). As discussed herein, some amino acids may have only a single charge state, while others may have two potential charge states. The rules may determine what situations dictate when to specify a given allowable charge state for an amino acid. There are four naturally occurring amino acids with charged side chains, and these charge states may have an impact on the calculation of the field points for peptides including those amino acids. Aspartic acid and glutamic acid have carboxyl groups on their side chains, which are fully ionized at pH 7.4. Arginine and lysine have sidechains with amino groups, which are fully protonated at pH 7.4.

All amino acids may exhibit variable ionization depending on pH and whether and how they are terminated. Although the neutrally-charged structure is commonly written, it is inaccurate because the acidic COOH and basic NH2 groups react with one another to form an internal salt called a zwitterion in the following intramolecular acid-base reaction: NH₂RCHCO₂H ⁻NH₃⁺RCHCO₂⁻ The zwitterion has no net charge; although at physiological pH (7.4) the H of the COOH group can move onto the NH2 group to create one negative (COO—) and one positive (NH3+) charge. Adding a termination or capping group, e.g. CONHCH3 (Ace) or NHCOCH3 (Nme) can mask this ionization potential. The sulfhydryl group of cysteine, phenolic hydroxyl group of tyrosine, and imidazole group of histidine also all show some degree of pH-dependent ionization. Depending on the application, the sidechain atoms of these amino acids may be specified with or without charges and in different ionization states. In any event, these charge and ionization states may be a characteristic that can be varied among different amino acid substitution matrices of a library thereof so as to provide a further dimension of context.

After the peptides' characteristics are specified for matrix construction (fewer or additional characteristics may be specified), process 300 proceeds to an operation 311, wherein variants for the specified sequence are instantiated (e.g., by a system for constructing context-specific, field-based amino acid substitution matrices; e.g., one or more of modules 711a-711n or other portion of system 700). As specified above, the “variants” may refer to instances of the peptide that have varying residues and rotamers at the variable position only, but that otherwise have static characteristics for the specified variables/characteristics (e.g., length, sequence, backbone conformation, sidechain conformation, charge and ionization state, etc.). These instantiated variants (and any 3D structures generated therefrom) may be considered “virtual” variants/peptides, as they exist in the computer environment.

As described herein, the residues inserted into the varying position for each variant may include each of a predetermined set of residues. In some implementations, this may include a given set of rotamer conformations for a given set of amino acids. In some implementations, more or fewer rotamer conformations may be used. In some implementations, more or fewer amino acid types may be used (with or without rotamers).

The variants differ from one another only at the selected variable position, thus fixing the “context” of the variable position. In some implementations, the amino acid at the variable position varies from among a set of amino acids. The set of available amino acids may be defined by the operator/investigator or otherwise defined. For example, the set of available amino acids may include the 20 naturally occurring amino acids. In some instances, modified amino acids may be included in the group. In other instances, the set of available amino acids may be otherwise constrained (e.g., only amino acids having aromatic rings, only basic residues, etc.).

In some implementations, the residue at the variable position varies from among a set of sidechain rotamer conformations for a set of amino acids. Each amino acid has a preferred set of sidechain conformations that it adopts in known protein structures. Rotamer libraries are datasets that depict the different preferred rotational conformations of the rotatable bonds in the amino acid's sidechains. These rotamer libraries can be assembled using observed x-ray protein structures. Different rotamer libraries may have different levels of “resolution” in that they may include data regarding a different number of rotamers for a given set of amino acids (typically, but not exclusively, the 20 naturally occurring amino acids). The level of resolution of a rotamer library used may be selected depending on the experimental needs of a given use, the computational capacity of the systems involved, and/or for other factors. For example, in some implementations, a rotamer library may be used that includes only data regarding the observed sidechain conformations in protein structures where the sidechain atoms have B values of less than 30, and have been clustered using a sidechain RMSD (root mean square distance) similarity cutoff of 1.0 Å. B values are otherwise known as “temperature factors” and describe how strongly a region of a structure is vibrating. High B values indicate that a portion of a structure is subject to larger vibrational modes and is therefore moving rapidly between different conformations. Such regions of structure are therefore less fixed and/or reliable for this type of analysis. Sidechains from these regions may be given less consideration (e.g., they may be ignored when constructing a rotamer library). Using a rotamer library reduces the sidechain conformational space (the number of different rotamers that are considered when comparing variations on the selected sequence) from the order of approx. 1×10⁹ to a much smaller number (e.g., under 500). In some implementations, a rotamer library that includes 129 total preferred conformations may be used (however, libraries having other numbers of conformations may be used). This may provide sufficient information regarding side chain conformations so as to provide useful results, but may be a small enough data set to avoid computational overload. If, for example, a rotamer library having 129 conformations is used, then 129 total variants may be generated for the construction of each matrix.

Interface 1500 of FIG. 15 illustrates a box 1513, which is an area or window that shows instantiated variants of a peptide having various specified constant characteristics. Box 1513 includes portions providing a unique variant ID number (abbreviated as UID), a matrix ID number, the sequence of each variant (using a combination of the single letter amino acid indicator and the numerical rotamer identifier to identify the specific residue and sidechain conformer at a given position in the variant), and the backbone conformation throughout the variant (illustrated after the abbreviation “Rama”). For brevity box 1513 shows only the first conformer (A1) for each matrix at the variable (9^{th}) position, whereas in fact peptides containing all combinations of sequence and sidechain rotamers are calculated at this variable position while the remaining characteristics stays the same. Box 1513 further shows the permutation of the sequence and sidechain conformer at position 10, each unique combination of which forms (in combination with the other non-variable positions) the non-variant context in which the variant combinations of sequence and sidechain rotamers at the variable position 9 are evaluated. Accordingly, a different matrix will be generated for each of the different peptides shown in box 1513 (hence each has a different matrix ID) by instantiation of variants for each of the illustrated peptides (i.e., that vary at the selected variable position). Being able to specify parameters for multiple matrices at a time (e.g., as described with respect to FIG. 15) enables faster and more efficient construction of matrix libraries.

In an operation 313, a predetermined number of 3D peptide structures are generated (one for each instantiated variant) using the specified parameters. In some implementations, one or more modules of a computer-implemented system for constructing amino acid substitution matrices may generate these structures (see e.g., modules 711a-711n or other portion of system 700 of FIG. 7). Construction of each 3D peptide structure may include first trimming a reference backbone-only structure (consisting of just N-C_{A}-C-O atoms) to the correct (i.e., specified) sequence length. The correct (i.e., specified) sequence of amino acid sidechains is then attached to the backbone by calculating the difference between the vectors formed respectively by the N-C_{A}-C_{B} bonds of the backbone and sidechain rotamer amino acids and using the rotation matrix generated to overlay the N, C_{A} and C_{B} atoms of the backbone and sidechain amino acids. The same rotation matrix is also applied to the remaining sidechain atoms of the rotamer, effectively attaching its atoms in their correct conformation to the backbone. Each sidechain to be attached is selected from the rotamer library for that amino acid in a specific rotamer conformation. In this way the geometry of the ‘take-off’ N-C_{A}-C_{B} atoms and the remainder of the newly attached side chain atoms is fixed in the correct position. Finally, the backbone phi, psi and omega angles are set by torsional rotations to their specified values.

In some implementations, this process may be managed by one or more of modules 711a-711n or other portion of system 700. For example, in some implementations, a 3D Structure Generator 711a may create the backbone, “decorate” it with the correct sidechains, adjust the torsion angles, and identify steric clashes and/or perform other operations to generate 3D molecular models as discussed herein.

In some implementations, the generated 3D models may be stored in a variety of 3D structure formats (including, for example, protein data bank (PDB) and structure data format (SDF)) in one or more of data stores 707a-707n or other portion of system 700 (e.g., a 3D Structure Library 707c).

In some implementations, in an operation 315, the number of variants may be intelligently reduced by considering steric clashes. This may be performed by an intelligent module or component of a computer-implemented system for generating context-specific, molecular field-based amino acid substitution matrices (e.g., a steric clash detection module 711b or other portion of system 700). For instance, if a given variant is generated in operation 311 that would result in steric clashes between atoms in any area of the peptide, this variant may be discarded from the set of generated 3D structures. In some instances, a steric clash may be indicated when the ratio of the distance between any of the atoms of one amino acid and any of the atoms of another amino acid is less than 0.6 times the sum of the van der Waals radii of the two atoms. Because the presence of a steric clash indicates that no molecule having this specific combination of features could exist in this conformation, it can be excluded, further reducing the problem space in an intelligent manner. In some implementations, consideration of these steric clashes may be performed by one or more modules of a system for constructing amino acid substitution matrices (e.g., modules 711a-711n of system 700).

In some implementations, in an operation 317, the molecular fields for each of the 3D models of the variants are calculated. In some implementations, the molecules on which fields are to be calculated may first be retrieved from a data store (e.g., 3D Structure Library 707c) in SDF format or other format. In some implementations, the fields may then be calculated on each of the molecules for a given matrix using a “force field” or field calculation tool of a computer-implemented system for generating context-specific, molecular field based amino acid substitution matrices (e.g., field calculation tool 709a of system 700). As discussed herein, in some instances, field calculation tools offered by Cresset Biomolecular Discovery Ltd (e.g., xedconvert from Cresset's XED™ force field tools) may be used (see also e.g., U.S. Pat. No. 7,805,257, which is hereby incorporated by reference herein in its entirety). The resulting field format data file (e.g., in XED format) may be stored in one or more of data stores 707a-707n or other portion of system 700 (e.g., a Fields Library 707b). The force field program/field calculation tool (e.g., tool 709a of system 700) may calculate the molecular electrostatic potential across the surface of the variant molecules. In some implementations, the field calculation tool may create a contour map around a generated 3D molecular structure at a van der Waals radius distance for one or more of 4 fields ([1] the positive electrostatic field of the molecule's surface; [2] the negative electrostatic field of the molecule's surface; [3]: the steric (shape/stickiness) properties of the molecule's surface; and [4] hydrophobic properties of the molecule's surface in its bioactive conformation).

In some implementations, the calculation of molecular fields in operation 317 may include the calculation of field points from the whole molecular fields. As discussed herein field points are indicators of the extrema of whole molecular field characteristics. These calculated field points may be used for the pairwise comparisons discussed herein. However, in some implementations, the whole fields themselves may be used. As discussed above, the fields and the field points may be stored in fields library 707b for rapid retrieval for later field comparison operations.

Once field models/field points for each of the variant peptides have been calculated, a similarity score is generated for each pairwise comparison of all of the variants in an operation 319. In some implementations, this may be performed by a field comparison scoring tool of a computer-implemented system for generating context-specific, molecular field based amino acid substitution matrices (e.g., a “fastqmf” field comparison tool 709b of system 700). As discussed herein, this may be done using the whole calculated molecular fields or field points derived therefrom. In some implementations, the similarity score may be generated by a function that gives a normalized score of the similarity between the fields of any two molecules presented to it. This function provides a single score for the overall similarity or distance between the fields and/or field points for two of the compared variants. This score is an average of an “A to B score” (i.e., when points sampled from molecule A are evaluated against the corresponding fields of molecule B) and a “B to A score” (i.e., when points sampled from molecule B are evaluated against the corresponding fields of molecule A), as the A to B score is not an exact match for the B to A score. The average of the A to B and the B to A scores is generated for a given pair of molecules (in this case, variant peptides). The resultant average score (the field similarity score) provides a measure of how well the fields of one of the generated peptide variants match the fields of another peptide variant. This similarity score is used as a measure of how similar the likely binding properties of those molecules will be. As many of variables/dimensions are held constant (e.g., sequence, backbone conformation, sidechain conformation, charge and ionization state, etc.), the variability in similarity scores is attributable to the specific sequence and rotamer variations at the variable position.

In some implementations, each pairwise comparison may be performed using a set of comparisons to evaluate the differences in the energy of each field. This comparison is performed for every unique pairwise comparison and on each of the molecular fields generated for those molecules. For example, for a given field the following formula may be used to obtain the energy score for an A to B comparison (wherein E=Energy, fp_{A}=field point A, size(fp_{A})=the radius of fp_{A}, F_{B}=function describing the distance between positions of fp_{A} and the corresponding fp_{B}, position(fp_{A})=the 3D coordinates of fp_{A}):

$${E}_{A -> B} = {\sum }_{{fp}_{A}} size ( {fp}_{A} ) \times {F}_{B} ( position ( {fp}_{A} ) ) .$$

The corresponding B to A score may be calculated using the following formula (wherein E=Energy, fp_{B}=field point A, size(fp_{B})=the radius of fp_{B}, F_{A}=function describing the distance between positions of fp_{B} and the corresponding fp_{A}, and position(fp_{B})=the 3D coordinates of fp_{B}):

$${E}_{B -> A} = {\sum }_{fpB} size ( {fp}_{B} ) \times {F}_{A} ( position ( {fp}_{B} ) ) .$$

The average score may be obtained as follows:

$${E}_{AB} = \frac{{E}_{A -> B} + {E}_{B -> A}}{2} .$$

The final similarity score may be obtained using (wherein S_{AB}=similarity):

$${S}_{AB} = \frac{2 {E}_{AB}}{{E}_{AA} + {E}_{BB}} .$$

In this final similarity score, the energy score for molecule A against itself and molecule B against itself (E_{AA}+E_{BB}) are used to normalize the pairwise similarity score to a value between 0 and 1 and take some account of differences in the size of molecules being compared. In some implementations, as part of a single context-specific, molecular field-based amino acid substitution matrix, similarity scores for pairwise comparisons of each peptide variant (for which fields/field points were generated) are then stored (e.g., in one or more databases 707a-707n).

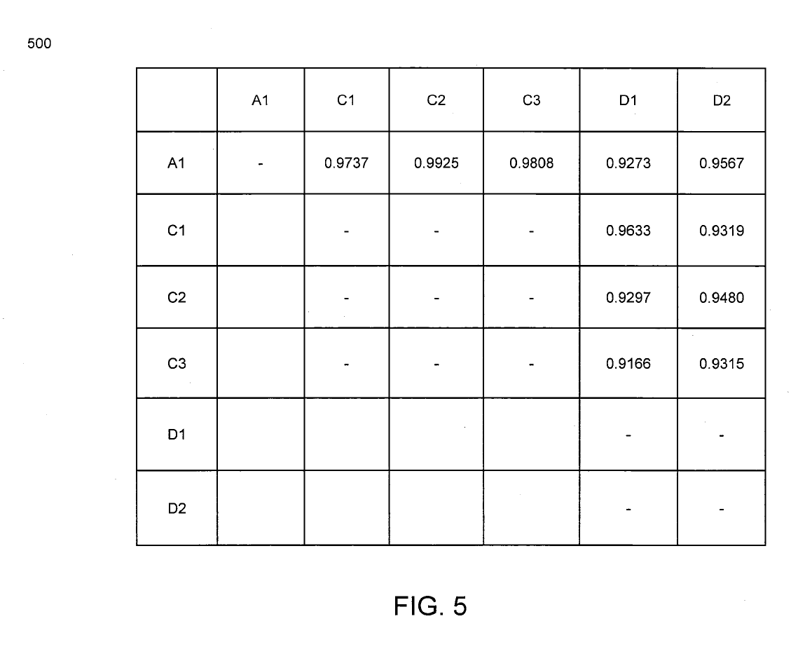

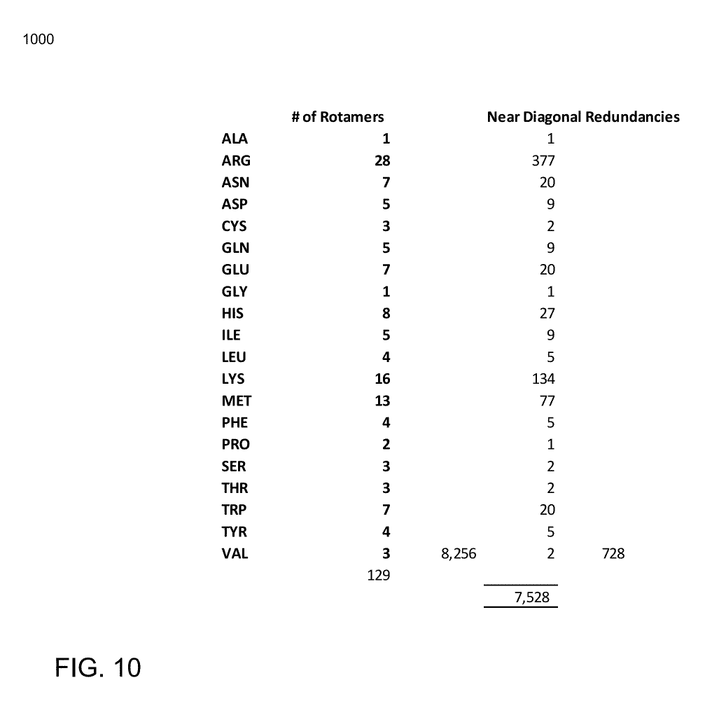

It is noted that, in some implementations, variants for different rotamer conformations of the same amino acid may not be compared to one another (e.g., because the amino acid in a physical environment is likely to fall into just one of the possible conformations). This gives rise to non-diagonal shapes in the field matrix values. See, for example, FIG. 5, which illustrates partial matrix 500, an example of a portion of a context-specific field based amino acid substitution matrix. The columns and rows are labeled with their identifiers for various rotamers for alanine (A1), cysteine (C1, C2, and C3), and aspartic acid (D1 and D2) as these represent the variations at the variable positions of the peptides used to construct this particular matrix (the characteristics of the remaining residues of the peptide that are held constant for all variants are not shown). Whenever identical rotamers or different rotamers for the same amino acid are paired with one another, a dash may be provided as the value, indicating that the value is not relevant. It is also noted that wherever a steric clash has previously been detected and the 3D structure of a conformer containing a given rotamer has been rejected, it will also not be possible to use that rotamer in the calculation of the matrix. This leads to a series of incalculable values (denoted as a row and column of scores of 0.0 corresponding to that rotamer) in the matrix; Otherwise, calculated similarity scores are shown. In instances wherein similarity scores for rotamers of the same amino acid (which may be called “near-diagonal redundancies”) are not calculated ((n²−n)/2)−1 comparisons can be removed, wherein n=the number of rotamers for a given amino acid. For a rotamer library having 129 entries, 8,256 possible pairwise comparisons are possible. However, because of the distribution of rotamers amongst the amino acids, 728 can be removed, leaving a matrix with a maximum of 7,528 meaningful scores (assuming no steric clashes). See e.g., FIG. 10, which illustrates table 1000, a table showing an example of the rotamer distribution for a specific rotamer library having 129 entries. Accordingly, when a 129 entry rotamer library is used to construct a matrix, the matrix may have 7,528 values (it may also be considered a 7,528 dimensional vector), when the near-diagonal redundancies are removed. It should be noted that all possible combinations of rotamers may not result in viable structures. There is a strong likelihood that steric clashes (discussed herein) will further reduce the number of values in a matrix, meaning that the context-specific substitution matrices are technically considered to be symmetrical sparse matrices.

In some implementations, in an operation 321, all of the similarity scores may be normalized, which may facilitate comparison of the scores between different matrices. Normalization may be performed so as to better enable comparisons of matrices having different static characteristics and increase the signal-to-noise ratio resulting from such comparisons. Factors considered for normalization may include peptide length, overall charge of a peptide, backbone conformation, and/or other factors. Substitution matrices are often expressed in log-odds form where the log-odds scores reflect the probabilities of transformation from one amino acid to another. In a log-odds form the scores matrix S is defined as:

$${S}_{i , j} = log \frac{{p}_{i} \cdot {M}_{i , j}}{{p}_{i} \cdot {p}_{j}} = log \frac{{M}_{i , j}}{{p}_{j}} = log \frac{observed frequency}{expected frequency}$$

Where M_{i,j} is the probability that amino acid i transforms into amino acid j and pᵢ is the frequency of amino acid i.

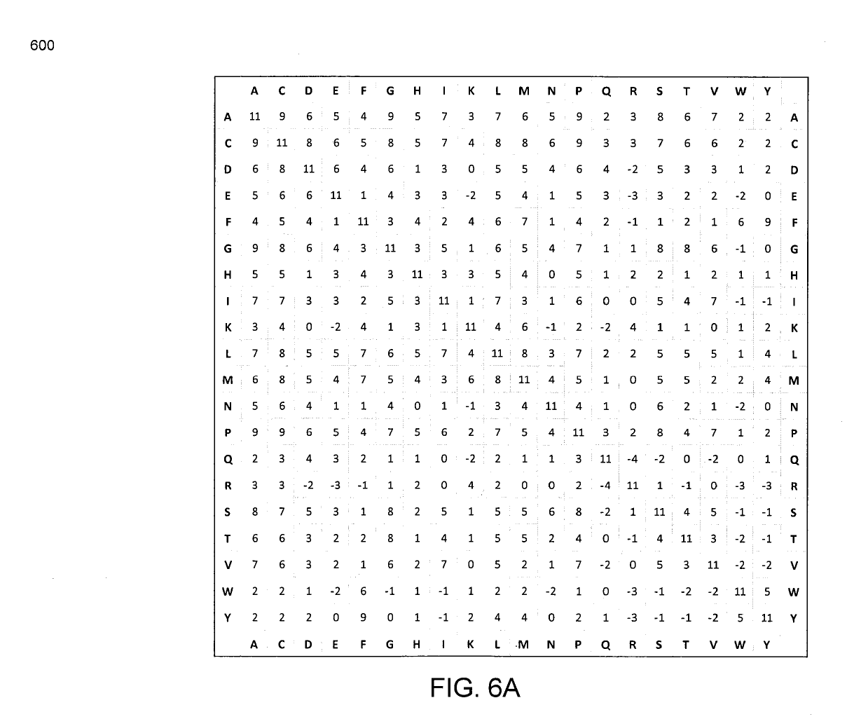

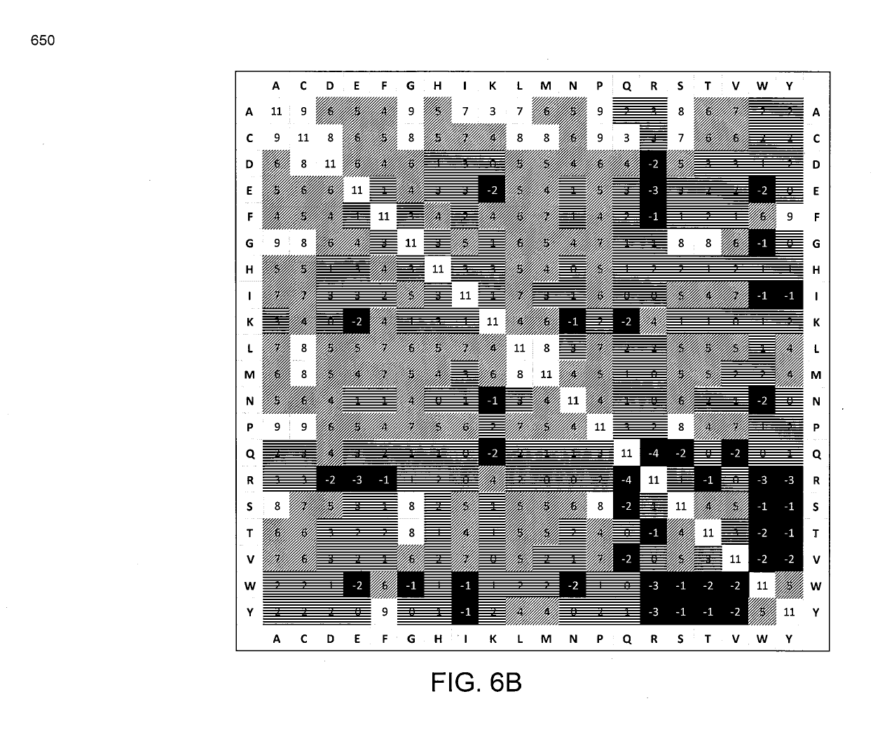

In an operation 323, the valid similarity scores may be assembled into a single context-specific, field-based amino acid substitution matrix. FIGS. 6A and 6B illustrate representations 600 and 650, both of which are examples of an assembled context-specific, molecular field-based amino acid substitution matrix. For simplicity, the matrix illustrated in FIGS. 6A and 6B, uses only the standard set of 20 naturally occurring amino acids, rather than a larger set including a rotamer library of amino acids. The areas of representations 600 and 650 which have low or negative numbers illustrate pairwise comparisons that have lower similarity scores (i.e., they highly differ from each other), while the areas with higher numbers represent comparisons that have more similarity to one another. Representation 650 illustrates these areas with hashing to indicate the magnitude of the similarity scores (−4 to −1 in solid black; 0 to 3 in heavy horizontal stripe; 4 to 7 in light diagonal stripe; and 8 to 11 in solid white)

As discussed herein, process 300 may be used to construct a single context-specific, molecular field-based amino acid substitution matrix. A library consisting of a plurality of context-specific, molecular field-based amino acid substitution matrices may be constructed using process 300 or similar process according to this disclosure. The various matrices in this library may differ on one of more of the specified characteristics (e.g., sequence, length, backbone conformation, sidechain conformation, charge and ionization state, etc.) that are held constant during single matrix construction. Therefore, the library provides multiple dimensions of information so as to provide a robust tool for peptide-based research and analysis. Accordingly, in some implementations, the matrix constructed using process 300 may be saved/stored (e.g., in a matrix library database/data store 707a of system 700) and process 300 may return to operation 301 wherein creation of an additional matrix for the library may be initiated.

In some implementations, any number of variables can be modified to create matrices for inclusion into a given library such as, for example, the length of the selected sequence, the sequence used to create a matrix, the variable position, the backbone conformation, the sidechain conformation, the charge and ionization states of the residues of the peptide, the set of available amino acids used for selecting the sequence, the set of amino acids/rotamers used to vary at the variable position, the characteristics of a rotamer library used for constructing variants of a selected sequence, the position of a small sequence motif in a larger peptide sequence and/or other variables.

In some implementations, empirical analyses may be used to evaluate the actual impact of a number of factors on molecular fields of peptides. These analyses can quantitatively evaluate changes on the similarity matrices generated for a specific combination of variables (e.g., sequence, backbone and sidechain conformations) and seek to identify ways in which the size of a similarity matrix library can be intelligently reduced by eliminating matrices that do not contain distinctive information. Factors that have been analyzed include the overall similarity between amino acids across all conformations. This enables identification of ‘synonymous’ amino acids (i.e., those whose substitution has little to no effect on the field points of a peptide) that can potentially be merged to reduce the peptide alphabet.

Other factors include the propensity of individual amino acids to participate in all secondary structural states in peptide structures (evaluated by analysis of NMR ensemble dwell conformations for peptides). For example, proline and glycine do not conform to standard backbone torsional preferences on a typical Ramachandran plot. Proline's phi angle is locked at −65°±13° and hence is rarely found in α or β structures as it tends to destabilize them. Proline is therefore more often found in β-turns.

In some implementations, a system for constructing a library of context-specific, molecular field-based amino acid substitution matrices is provided. FIG. 7 illustrates a system 700, which is an example of a system for constructing context-specific, molecular field-based amino acid substitution matrices (and/or a library thereof). In some embodiments, system 700 includes a control application 701, one or more computing devices 703a-703n, at least one input device 705, one or more data stores 707a-707n, one or more interfacing components 709a-709n, and/or other elements. The features and functions for constructing context-specific, field-based amino acid substitution matrices may be enabled by systems such as system 700.

In some implementations, control application 701 may be or include one or more computer applications that operate on or across one or more computing devices 703a-703n. Control application 701 may be a software application that includes instructions that cause one or more processors of one or more computing devices 703a-703n to perform one or more of the amino acid substitution matrix library construction functions (or other functions) described herein. In some embodiments, control application 701 may include one or more modules 711a-711n that may comprise instructions for performing one or more of the amino acid substitution matrix library construction functions (or other functions) described herein such as, for example, receipt of length parameters, receipt of sequence selections, receipt of variable positions, receipt of backbone conformations, receipt of charge states, instantiation of variants, receipt or construction of 3D molecular models (e.g., 3D structure generation module 711a), receipt or determination of steric clashes from among variants (e.g., steric clash detection module 711b), receipt or calculation of molecular fields and/or field points, pairwise comparison of molecular fields and/or field points, similarity scoring, assembly of matrices, construction of sub-matrices, comparison of matrices, and/or other functions. Other modules, including those of other applications/programs may comprise or may interface with control application 701 and/or one or more of modules 711a-711n.

One or more computing devices 703a-703n may be one or more servers, personal computers, or other computing devices having one or more processors, (including microprocessors 717 and/or graphical processing units GPUs 715), memory devices, and/or other computer elements enabling performance of the features and functions described herein. In some implementations, one or more of control application 701 and modules 711a-711n may be distributed among a plurality of computing devices 703a-703n. In some implementations, computing devices 703a-703n may be geographically distributed and therefore may be connected via one or more computer networks (e.g., a local area network, a wide area network, the internet, an intranet, etc.).

At least one input device 705 may be or include a computing device that supports various hardware devices (e.g., keyboards, mouse, touch screen, display screen, and/or other hardware devices) and software components (e.g., graphical user interfaces) for enabling receipt of information from (and presentation of information to) a user to control application 701 and/or other components of system 700. In some implementations, input device 705 may be part of or otherwise supported by one or more of computing devices 703a-703n. In some implementations, a computing device supporting input device 705 may be connected to one or more of computing devices 703a-703n (e.g., via a wireline connection, wireless connection, over a network, etc.).

One or more data stores 707a-707n may be or include relational databases, non-relational databases, directories, or other data storage mechanisms for storing data used in iterative library screen enrichment. For example, one or more data stores 707a-707n may include stores of information relating to peptide backbone conformations (e.g., Ramachandran plot generators, plots, information regarding allowed and disallowed backbone formations for amino acids and peptides.), information relating to amino acid and peptide charge states, rotamer libraries, information relating to generation of 3D molecular models for peptides, information relating to calculation of molecular fields and field points for peptides, data storage for instantiated variants, generated 3D molecular models, generated molecular fields and field points, generated similarity scores, assembled matrices and sub-matrices, and/or other information storage for data generated in the construction of context-specific, field-based amino acid substitution matrices. In some implementations, the various databases of system 700 may be supported by or run on one or more database servers such as, for example one or more database servers 713.

One or more interfacing components 709a-709n may include additional modules, applications, data stares, websites, input devices, and/or, other components wherein information can be exchanged therewith (and operations performed thereby) for constructing context-specific, field-based amino acid substitution matrices. For example, Ramachandran-based allowed/disallowed backbone conformation program, a force field/field calculation program (field calculation component 709a) for calculating molecular fields and/or field points, remote rotamer library, 3D molecular model generating application, structure conversion, field comparison (field comparison component 709b), and/or other resource may interface with control application 701 to enable any operation for constructing context-specific, field-based amino acid substitution matrices. It should be noted that the illustrated components 709a-709, in some implementations, may also be structured/included as one or more of modules 711a-711n. Similarly, one or more of modules 711a-711n and the functions thereof, in some implementations may be structured/included as one or more of components 709a-709n.

As discussed herein, a multitude of context-specific, field-based amino acid substitution matrices can be generated using processes such as process 300 and systems such as system 700. These matrices may be assembled into a library of context-specific, field-based amino acid substitution matrices. In some implementations, a single context-specific field based amino acid substitution matrix can be used to construct a plurality of sub-matrices. These sub-matrices may be constructed such that each amino add is represented only once per sub-matrix. Therefore, if the standard set of 20 amino acids is used for full matrix construction (even if a rotamer library of different rotamers for one or more of the standard 20 amino acids is used in construction of the overall matrix), each sub-matrix will be a 20×20 matrix that includes a unique combination of the amino acid rotamers that were used to construct the full matrix. These 20×20 (or other dimensional) sub-matrices may enable more accurate and/or manageable comparison with other 20×20 matrices. As discussed below, improved iterative peptide screens processes and consensus field pharmacophore construction may utilize 20×20 matrices (rotamer considerations are not used in certain parts of these processes). Therefore, construction of these 20×20 sub-matrices is useful for processes such as discussed herein (see e.g., process 800 and 1400).

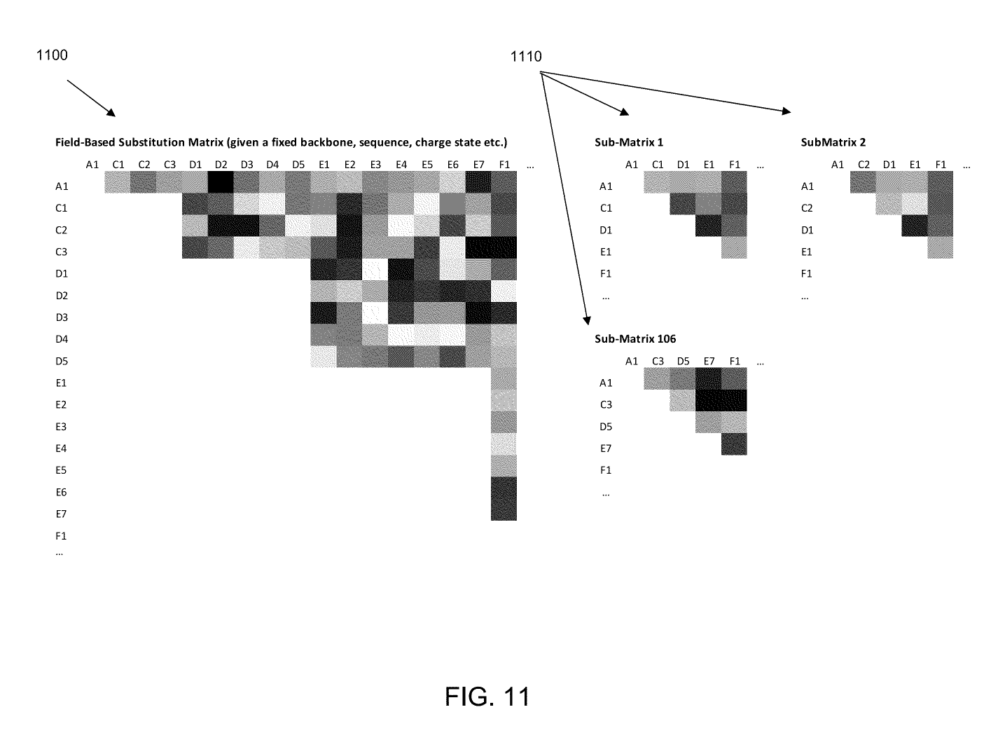

In some implementations, sub-matrices may be constructed for each different combination of rotamers for each amino acid. In some implementations, these matrices may be constructed by one or more of modules 711a-711n of system 700 and stored in matrix library 707a. FIG. 11 illustrates graph 1100, which is an example of a portion of a full context-specific, field-based amino acid substitution matrix. FIG. 11 also illustrates graphs 1110, which are examples of portions of sub-matrices constructed by permuting the combinations of sidechain rotamers in the full matrix of graph 1100. As can be seen in FIG. 11, the full matrix includes rows and columns for each rotamer of each amino acid (see e.g., C1, C2, C3, etc.). The sub-matrices include only one rotamer representative for each amino acid. In some implementations, all possible permutations of sub-matrices may be constructed for a given full matrix and stored in the matrix library. In the case of the 129 rotamer library discussed herein, this full matrix would contain (n_{A}.n_{C}.n_{D}.n_{E}.n_{F}.n_{G}.n_{H}.n_{I}.n_{K}.n_{L}.n_{M}.n_{N}.n_{P}.n_{Q}.n_{R}.n_{S}.n_{T}.n_{V}.n_{W}.n_{Y}) where n_{X} is the number of rotamers of the amino acid in question used in the construction of the full matrix. This equates to approximately 1.5×10¹⁴ different sub-matrices for matrices constructed using the 129 rotamer library shown in FIG. 10, each containing a maximum of 190 meaningful values. As this number is very large, in some implementations the sub-matrices may be decomposed from the full matrix ‘on-the-fly’ as required and special techniques such as the use of knowledge of the structure of the sequence/rotamer combinations of the full matrices and fast matrix comparisons on massively parallel GPUs may be used to analyze them. Other analytical techniques such as singular value decomposition may be selectively applied to the full matrix or portions thereof to determine which sub-matrices are most likely to contain interesting information before these are extracted and tested.

As discussed herein, comparison of generated matrices may be useful. Both whole context-specific, molecular field-based amino acid substitution matrices and the sub-matrices that they define can be compared to one another (or to other matrices of the same size) using a variety of methods such as, for example, array matching, vector matching, wavelet analysis, linear algebra, and/or other techniques known to those having skill in the art. In some implementations, n dimensional vectors representing the pairwise scores in two compared matrices can be compared by calculating the dot product between the vectors using the formula below (where n=190 for a 20×20 matrix) to evaluate the similarity between whole substitution matrices:

$$a \cdot b = {\sum }_{i = 1}^{190} {a}_{i} {b}_{i}$$

This dot product provides a single score that represents the overall pairwise similarity of two matrices. It may not necessarily elucidate the detail of how homogenously the deviations in this overall similarity are distributed. More detailed levels of pairwise matrix comparison can also be examined using other methods. For example, maximum deviation metrics describing the distribution of similarities between a specific pair of amino acid in two matrices can be determined on the matrix as a whole, by amino acid physicochemical type or by individual amino acid.

In some implementations, the comparison of matrices (known mathematically as arrays or sparse matrices (matrices incorporating a number of cells with no or zero value)) can be accelerated using a variety of massively parallel computing techniques, including the use of graphical processing units (GPUs). Systems and methods for constructing and using context-specific, field-based amino acid substitution matrices may leverage GPUs for computing capability to perform some of the features and functions described herein. See e.g., GPUs 715 of system 700, GPUs 915 of system 900 and GPU's 1415 of system 1400. GPUs can provide supercomputing performance using conventional graphics-based computing devices. They can be used to build highly scalable and cost-effective analysis solutions for suitable applications. GPUs gain their performance by having a large number of processor cores per chip. Whereas a desktop processor (i.e., CPU) may have 2, 4, or even 6 processor cores per chip, even a single low-cost PC graphics card may have 512 GPU cores. When rendering a scene in a graphical application, the graphics card splits a whole screen into a series of smaller squares (an array of pixels). Each of these pixel arrays is rendered by a single GPU core, and the results recombined into a whole picture, taking advantage of the graphics card's massively parallel computing power.

The systems and methods described herein can make use of large parallel computing capability of certain devices via the compute unified device architecture (CUDA) and OpenCL programming languages. Matrix comparison algorithms can work up to 200× faster on a GPU than an equivalently priced CPU due to their efficient exploitation of array operations in the massively parallel architecture. Combined with an efficient data and problem representation, this allows the systems and methods described herein to operate with dataset sizes and complexities that would be prohibitively expensive and slow on a standard computing architecture. For example, pairwise comparison of a test set of 6,041 matrices takes around 2 seconds on a machine with 4 GPU devices (2 Nvidia GTX 590s with a total of 1,960 GPU cores), compared to over half an hour on a Core i7 4 core Intel CPU.

In some implementations, the invention provides methods and systems for using a library of context-specific, molecular field-based substitution matrices to optimize iterative peptide screening systems. The optimization of an iterative peptide screen using a library of context-specific, molecular field-based amino acid substitution matrices uses knowledge gained from previous screens to identify previously unsampled areas of the peptide sequence space that may contain better binding sequences and to create a new population of peptides that can probe this space effectively. Specifically this means using knowledge of which sequences bind, how frequently they occur in a given population and ideally how strongly they bind to the target of interest. In some instances, knowledge of which sequences are known not to bind (i.e., those peptides in a screen that do not score as binding proteins) is also used, as such knowledge can provide useful negative data. The amino acid similarity matrix library discussed herein enables the next generation of peptide sequences to be targeted/engineered so as to have a greater likelihood of scoring as binders. The peptide screening systems/processes (e.g. systems/processes 101 of FIG. 1) can be used to generate a range of information that is very useful for directing the design of the next enriched generation of peptide sequences such as, for example, the sequences of binding peptides, the frequency of each sequence's occurrence in the binding/non-binding population, the binding affinity of each sequence (e.g., assessed by multiplexed competitive binding assays on arrays), and/or other information.

FIG. 8 illustrates a process 800, which is a process for using a library of field based amino acid substitution matrices to optimize an iterative peptide screen. In some implementations, process 800 may be used to identify sets of sequences that are likely to bind to the target in the screen. Non-standard and modified amino acids may be used as well as the standard set of 20 naturally occurring amino acids.

In an operation 801, a protein target against which binding peptides are to be tested is selected. This selection may be entered into an interface of or otherwise received by a computer-implemented system for iterative library enrichment (see e.g., FIG. 9). In an operation 803, an initial library of peptides is developed for the screen. In some implementations, this initial library may be randomly generated. Therefore the initial screening round typically has the most diverse sequence population and consequently provides the highest overall information content. The initial screen is then run in an operation 805. As discussed herein, the screen may consist of immobilizing the target on a substrate (this may be done in a large number of different wells or substrate plates). The substrate is then exposed to the library of peptides and binders are detected (e.g., using fluorescence, dyes, voltage change across a membrane, resistance changes in an excited cantilever system, etc.).

The results of the initial screen are analyzed in an operation 807. In some implementations, this analysis may be performed or assisted by, or the results communicated to a computer implemented system for iterative library enrichment (e.g., one or more modules 911a-911n of system 900). In some implementations, analysis may include use of a sequencing machine, e.g., an Illumina genome sequencer. The analysis may include determining the peptide sequence of the peptides from the library that are found to bind to the target. In some implementations, the peptide sequence may be determined by sequencing a cognate DNA coding sequence that is attached to the peptide. The binding affinity of each of the peptides in the library may be evaluated using a multiplexed competitive binding array technology, which may be run under multiple conditions to evaluate the sensitivity of the binding. Each peptide in the screen may be assigned a frequency score that indicates how often it is observed in the population of binding peptides. This may be used in the absence of direct experimental binding affinity or similar data to estimate its binding affinity for the target. Each peptide for which no affinity is found may be given a score of zero. Those peptides that score higher are those that are found to have a higher affinity. This scoring information (including information regarding peptides that do not bind) can be used as part of the investigation into which regions of the sequence of a peptide contribute to its binding to the target. The scores and other information (e.g., determined sequence, identifier) regarding each peptide may be stored in a database or other storage system of a computer-implemented system for library enrichment (see e.g., database 907a of system 900).

In an operation 809, the peptides from the initial library are aligned (again, in some implementations, these may include binding peptides and non-binding peptides). Since the peptides in the binding library will by design all be of a uniform specified length, the initial alignment required in this case is a simple process of laying out the sequences in order. This alignment may be performed by one or more modules of a computer-implemented system for library enrichment (see e.g., a “seqAlign” alignment module 911a of system 900).

In some cases it may be necessary to perform a sequence analysis to identify the most conserved regions of the binding sequences, which may represent the binding regions of the peptide. In some cases, only a small section (motif) of the whole peptides is actually involved in binding to the target and a conserved motif (e.g. a 6-mer F X D X X Y, may be determined to be responsible for the binding, wherein X is a fluctuating residue). This motif can in principle (but subject to target specific constraints) occur at any position of the binding peptide sequence. For example, valid sequences of 17-mer binding peptides might be as follows in Table 1:

| | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| Peptide1: | A | F | E | D | S | T | Y | F | Y | I | K | L | H | P | Q | Y | A |
| Peptide2: | A | D | E | T | T | Y | F | Y | D | G | G | Y | L | K | D | W | M |
| Peptide3: | D | D | E | R | T | F | F | Y | D | G | K | Y | H | M | Q | V | I |
| Peptide4: | E | Y | E | F | T | D | F | F | Y | I | K | N | G | N | E | T | L |
| Peptide5: | D | D | E | R | S | F | Y | Y | G | F | G | D | C | Q | Y | S | P |

The binding motif F X D X X Y is shown highlighted in each sequence in bold. The position of the likely binding motifs can be determined (e.g., in an operation 811, by e.g., a “findMotif” motif detection module 911b of system 900) by a variety of standard biophysical and bioinformatics techniques such as amino acid substitution scanning (which evaluates the effect of replacing each successive amino acid of a binding peptide sequence on its binding) and sequence identity analysis (which looks for correlated patterns of conserved identical sequence across the sequences).

Table 2 shows an example of aligning 12-mer binding motifs from 5 peptides from a screening run-note: that many more peptides will result from an actual run, likely on the order of hundreds to thousands of binding peptides and potentially hundreds of thousands of non/partial binders).

TABLE 2

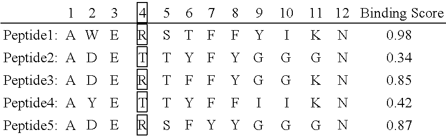

In an operation, 813, a position on the peptide alignment (e.g., of the aligned peptides or of some/all occurrences of an identified binding motif—e.g., col. 4 of Table 2) is selected (e.g., a user may select the position of the alignment from a GUI presented by a computer-implemented system for library enrichment; e.g., a GUI provided by one or more modules 911a-911n of system 900). In some implementations, this selection may be automated (e.g., based on one or more factors) or made/entered manually. In some implementations, as process 800 iteratively cycles, all positions of a peptide alignment may eventually be selected, but the regions that are known or suspected contribute to binding (e.g., identified motifs) may be selected earlier in the iterative progression.

In an operation 815, at the selected position, a relative activity score is calculated (e.g., by a “calcRAS” score calculation module 911b of system 900) for each different amino acid that occurs in any of the aligned screened peptides at the selected position based on the observed frequency of that amino acid in the binding and/or non-binding peptide populations at that position in the alignment. For example, in the alignment shown above in Table 2 there are five sequences, each with a binding score. At position 4, there are five amino acids, three of which are ARG (R) and two of which are THR (T). The ARGs appear in peptides that consistently have a higher binding affinity (0.98, 0.85 and 0.87) than those containing THRs (0.34 and 0.42) at that position. The relative activity score for R in this case would be higher (average=0.9) than T (average=0.38). Each of the 20 amino acids (assuming each of them occurs at the selected position) can thus be assigned a relative activity score for the selected position of the peptide.

In some implementations, these relative activity scores can be normalized and/or weighted in an operation 817. In some cases, it may be desirable to weight the relative activity scores to better account for the known contribution of a given amino acid to the overall binding of the peptide as determined by amino acid substitution scanning. This maximizes the relative contribution of important positions in the binding motif. In other cases, for example with a very conserved sequence profile at one position, it may be beneficial to weight and/or normalize the scores such that the range of the observed scores for certain amino acid types is increased or decreased to allow for better discrimination of other potential binding sequences. In some implementations, the normalization and/or weighting may be performed by a computer implemented system for iterative library enrichment (e.g., the “calcRAS” score calculation module 911c of system 900).

Normalization may be performed in a number of ways such as, for example, using log-odds methods which express the scores in terms of the probabilities of transformation of one amino acid into another.

Weighting of the relative activity scores for an amino acid at the selected position may use knowledge of the amino acid's frequency of occurrence at the selected position in binding and/or non-binding peptides. For example, the more frequently an amino acid occurs in the population of aligned binding peptides, the more heavily that amino acid may be weighted, whereas the more frequently it occurs in non-binding sequence, the less heavily it may be weighted. In some implementations, the weighting may utilize direct experimental information measuring the binding affinity of the specific peptide sequences. In some implementations, the weighting may utilize information obtained from amino acid substitution scanning (repetitive replacement of successive amino acids followed by binding/activity testing) in which those amino acids occur at the selected position. In some implementations, multiple weighting methods may be used together (including those discussed above). In any instance, use of a weighting technique on the calculated relative activity scores may be used so as to take into account different factors/realities relating to known information from a binding screen or the peptides thereof so as to more intelligently reflect the effect that a given amino acid may have on binding.

In an operation 819, an observed distance matrix between the amino acids at the selected position in the alignment is generated by pairwise comparison of the relative activity scores for each amino acid present at the selected position against all of the other amino acids present at the selected positions (i.e., evaluation of the similarity/distance of the relative activity scores for each pairwise combination of amino acids). In the case of a matrix generated using just naturally occurring amino acids, this will result in a symmetrical 20×20 observed distance matrix (often times, and typically after an initial screening run, all 20 amino acids will be present at the selected position at least once; if not all 20 amino acids are present at the selected position, it may be given a relative activity score of 0; ensuring a 20×20 matrix). The comparison may include generating a measure of the difference or similarity between the two relative activity scores of each amino acid (as described herein, in some instances these scores may have been normalized and/or weighted). Difference/distance matrices and similarity matrices are closely related, with high values indicating dissimilarity in a distance matrix, but similarity in similarity matrix. For a given pair, the corresponding cell's value (X) in a distance matrix would be 1-X in a similarity matrix. In some implementations, the process described herein uses both distance and similarity matrices based on the same underlying pairwise similarity scores. The comparison may include calculating a ratio of the compared relative activity scores (wherein an amino acid compared against itself yields a similarity of 1) or may reflect the mathematical difference between the two relative activity scores (e.g., if relative activity scores range from 0 to +1, then the differences can range from 0 to +1). A variety of other distance metrics may also be used including simple Euclidean (root mean squared) distance, weighted distance, log-odds and other methods. The resultant observed distance matrix will be symmetrical and have identical diagonal values (due to the occurrence of amino acids being compared to themselves), therefore resulting in a matrix containing 190 meaningful pairwise similarity values (for a 20×20 matrix). The values contained in matrix may be scaled beyond a 0 to +1 distribution by the methods described above. In this, it is identical in form to the matrix described in FIGS. 6A and 6B.

In some implementations, the generation of the observed distance matrix may be performed by a computer implemented system for iterative library enrichment (e.g., by a “calcOMat” matrix calculation module 911d of system 900).

In an operation 821, this observed distance matrix is compared (e.g., by a “scoreMat” matrix comparison module 911e of system 900) against sub-matrices in a context-specific, molecular field-based amino acid substitution matrix library (e.g., a library comprising substitution matrices generated using a process such as for example, process 300). In some implementations, the observed distance matrix may be compared against all of the sub-matrices in the library. In some implementations, the observed distance matrix may be compared against a subset of all of the sub-matrices in the library. The comparison of the observed distance matrix is performed against the sub-matrices because the sub-matrices will be of the same shape (likely 20×20) as the observed distance matrix. As the alignment and relative activity score calculations do not take rotamers into account, the observed distance matrix is also likely a 20×20 matrix unless non-naturally occurring amino acids are included or less than all 20 naturally occurring amino acids are used.

In order for this comparison to be performed exhaustively, all of the sub-matrices contained in each of the field-based substitution matrices must be generated (as shown in 1110 in FIG. 11) via permutation of data in the larger matrix and compared separately. In some implementations, the sub-matrix calculation may be performed by a computer implemented system for iterative library enrichment (e.g., by a “genSubMat” sub-matrix generation module 911f of system 900).

The comparison between the observed distance matrix and the generated sub-matrices can then be performed (e.g., by one or more modules 911a-911n of system 900). Various methods may be used for this comparison such as, for example, array matching, vector matching, wavelet analysis, linear algebra, and other techniques known to those having skill in the art. In one implementation, a vector-based comparison is made between a vector calculated from the observed distance matrix and the vectors calculated from each of the sub-matrices in a library of field based amino acid substitution matrices (e.g., the library matrices generated using a process such as process 300) using one or more metrics including dot product and/or maximum deviation metrics. n dimensional vectors representing the pairwise scores in two compared matrices can be compared by calculating the dot product between the vectors using the formula below (where n=190 for a 20×20 matrix) to evaluate the similarity between whole substitution matrices:

$$a \cdot b = {\sum }_{i = 1}^{190} {a}_{i} {b}_{i}$$

This dot product provides a single score that represents the overall pairwise similarity of two matrices. It may not necessarily elucidate the detail of how homogenously the deviations in this overall similarity are distributed. More detailed levels of pairwise matrix comparison can also be examined using other methods.

In some implementations, the use of GPUs and/or GPU associated computing techniques may be used to accelerate the comparison of the observed sequence matrix against the various sub-matrices generated by permutation/decomposition of the field-based substitution matrices. The GPU techniques are particularly suited to SIMD (Single Instruction, Multiple Data) work (i.e. using the same algorithm to evaluate the similarity of thousands of different sub-matrices to the target (the observed sequence matrix) on all of the various GPU cores simultaneously). In this fashion several thousand small processors all perform the same job and therefore may provide computational tractability for large comparisons (as with comparing the observed distance matrix to the multitude of sub-matrices). Accordingly, in some implementations, a plurality (e.g., on the order of hundreds to hundreds of thousands) of GPU cores may be used to perform these comparisons (see e.g., GPUs 915 of system 900).

In an operation 823, a definable size set of the sub-matrices that are most similar to the observed distance matrix is selected. In some implementations, the selection may be performed by a computer implemented system for iterative library enrichment (e.g., by a selection module 911g of system 900). The selected matrices are the “preferred” matrices whose internal pattern of variance across the amino acids relative to each other matches most closely the pattern of sequence distribution observed for the selected position in the peptide or binding motif alignment. This sequence distribution (and the relative activity scores that are calculated from it, contained in the observed distance matrix) is a direct biological measurement of the preferred amino acids in the binding peptides at that position in the binding sequence/motif. By identifying the sub-matrices where the pattern of variability in the amino acids' fields most closely matches the observed pattern of variability in the amino acids' contribution to binding, the most likely structural and sequence context of that amino acid position in the binding peptide can be identified, as the description of these contexts is explicitly stored as part of the matrix and sub-matrix descriptions. In some implementations, one or more thresholds may be set (e.g., by an administrator or intelligently selected in an automated fashion) so that sub-matrices that are as similar or more similar to the threshold may be considered “preferred.” The threshold may be set by numerical limit (e.g., similarity>0.96) or by categorical value (e.g., top 10 most similar sub-matrices).

In an operation 825, the amino acids that most closely resemble (i.e., have the highest similarity score in the preferred sub-matrices) those observed to be most present at the selected position of the binding sequences may be determined to be “preferred” amino acids for the selected position. In some implementations, these determinations may be performed by a computer implemented system for iterative library enrichment (e.g., by selection module 911g of system 900). For example, if a plurality of amino acids are present on the alignment at the selected position (which is highly likely), each of these amino acids is used to select preferred amino acids from the identified preferred sub-matrices. For each amino acid present at the selected position, the amino acid is located in each of the preferred sub-matrices (while the amino acid distribution from the peptide screen or binding motif alignment has no rotamer information associated with it, the corresponding amino acids from the sub-matrices include one rotamer variant for each amino acid). Amino acids in the preferred sub-matrices having high similarity scores with the amino acid from the alignment may be chosen as preferred amino acids. In some implementations, this selection procedure may be followed for all of the amino acids present in the alignment as the selected position. In some implementations, this selection procedure may be followed for only a subset of the amino acids present in the alignment at the selected position (e.g., those with highest frequency of binding; those with highest relative activity scores; or other criteria). These selected (preferred) amino acids may be considered to provide the best binding characteristics and therefore are used in the next generation of peptides at that position in the sequence for construction of a screening library.

Process 800 may return to operation 813 so as to repeat operations 813 through 825 for a different position in the peptide alignment. In some implementations, operations 813 through 825 may be performed for each position in the alignment. In this manner, a set of preferred amino acids is identified at each position in the peptide alignment. These can be used to create the next generation of screening library (i.e., different combinations of the preferred amino acids at each position). In some implementations, operations 811-823 may not be repeated for each position of the alignment, but only for certain positions of interest (e.g., for those positions in a known or suspected binding motif). Accordingly, the preferred amino acids at each position of the binding peptide (or those of a motif) are determined.

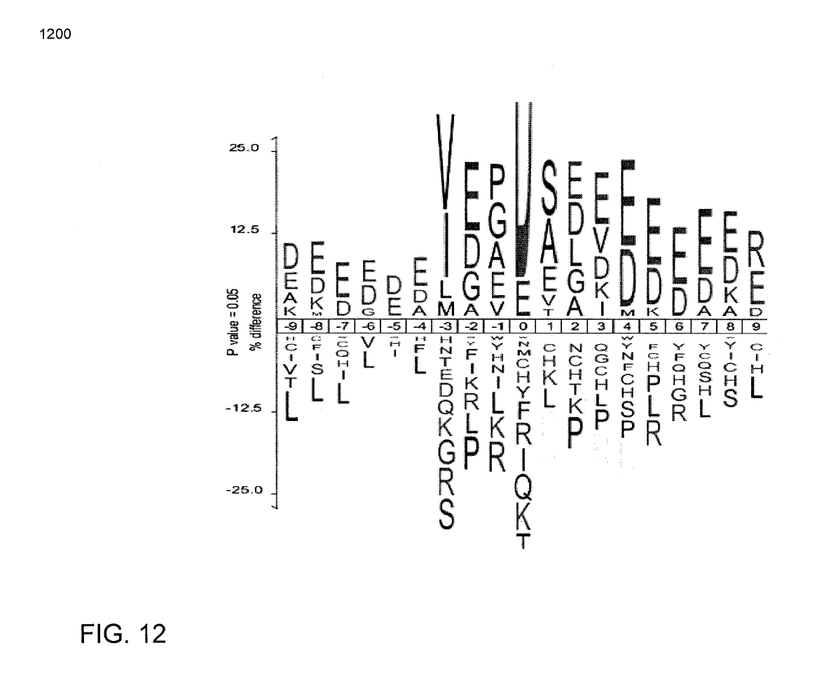

FIG. 12 illustrates a graph 1200, which illustrates selected preferred amino acids resultant from matrix comparison and amino acid selection processes such as operations 819-823. In some implementations, the selected amino acids may be differentially displayed based on certain characteristics thereof (e.g., estimated contribution to binding). For example, the elongated/enlarged letters above the X-axis may indicate that such amino acids contribute heavily to binding. Those below the line contribute negatively to binding. Other differential indicators (e.g., color) may be used to indicate other characteristics).

Once those desired positions have been through operations 813-825, a subsequent library of peptides containing novel sequences that are predicted to be stronger binders is formulated for a subsequent screen in an operation 827. This may involve the permutation of various preferred amino acids predicted to contribute to strong binding at each position of the peptide into a library of specified size. In some implementations, the subsequent screening library may be calculated by a computer implemented system for iterative library enrichment (e.g., one or more modules 911a-911n of system 900). This subsequent library may be compared against a database of sequences that have been previously tested against the selected target in an operation 829. In some implementations, this comparison may be performed by a computer implemented system for iterative library enrichment (e.g., one or more modules 911a-911n of system 900). If any of the specific sequences arising from the preferred sequence combinations (in the subsequent library) has already been tested in a previous screen, they may be discarded (or may be included to evaluate competitive binding versus new sequences, depending on the stage and state of the screening runs). The subsequent library is an enriched population of sequences that are clustered around the known binding sequences but which uses information from all of the binding peptides to target the search at each amino acid of the peptide to identify optimal binders.

FIG. 9 illustrates a system 900, which is an example of a system for using a library of context-specific, molecular field-based amino acid substitution matrices to optimize an iterative peptide screen. In some implementations, system 900 includes a control application 901, one or more computing devices 903a-903n, at least one input device 905, one or more data stores 907a-907n, one or more interfacing components/systems 909a-909n, and/or other elements. The features and functions for using a library of field based amino acid substitution matrices to optimize an iterative peptide screen (e.g., process 800) may be enabled by systems such as system 900.

In some implementations, control application 901 may be or include one or more computer applications that operate on or across one or more computing devices 903a-903n. Control application 901 may be a software application that instructs one or more processors of one or more computing devices 903a-903n to perform one or more of the iterative library construction functions (or other functions) described herein. In some embodiments, control application 901 may include one or more modules 911a-911n that may comprise instructions for using a library of field based amino acid substitution matrices to optimize an iterative peptide screen (or other functions) described herein such as, for example, receipt and analysis of peptide screen results, alignment of peptides from a screening run, identification of binding motifs in an alignment, selection of a position from a peptide alignment, calculation of relative activity scores, normalization/weighting of relative activity scores, calculation of observed distance matrices, generation of sub-matrices from whole context-specific molecular field-based amino acid substitution matrices, comparison of observed distance matrices against context-specific molecular field based amino acid substitution matrices and/or sub-matrices thereof (including using GPUs 915 for this operation), selection of preferred matrices, selection of preferred amino acids, formulation of screening library peptides using preferred amino acids, comparison of a formulated library against prior screens, and/or other features and functions. Other modules, including those of other applications/programs may be used or may interface with control application 901 and/or one or more of modules 911a-911n.

One or more computing devices 903a-903n may be one or more servers, personal computers, or other computing devices having one or more processors, (including, for example, microprocessors 917 and/or GPUs 915), memory devices, and/or other computer elements enabling performance of the features and functions described herein. In some implementations, one or more of control application 901 and modules 911a-911n may be distributed among a plurality of computing devices 903a-903n. In some implementations, computing devices 903a-903n maybe geographically distributed and therefore may be connected via one or more computer networks (e.g., a local area network, a wide area network, the Internet, an intranet, etc.).

At least one input device 905 may be or include a computing device that supports various hardware devices (e.g., keyboards, mouse, touch screen, display screen, and/or other hardware devices) and software components (e.g., graphical user interfaces) for enabling receipt of information from (and presentation of information to) a user to control application 901 and/or other components of system 900. In some implementations, input device 905 may be part of or otherwise supported by one or more of computing devices 903a-903n. In some implementations, a computing device supporting input device 905 may be connected to one or more of computing devices 903a-903n (e.g., via a wireline connection, wireless connection, over a network, etc.).

One or more data stores 907a-907n may be or include relational databases, non-relational databases, directories, or other data storage mechanisms for storing data used in construction of context-specific, field-based amino acid substitution matrices. For example, one or more data stores 907a-907n may include stores of information relating to peptide screening data (including peptide sequences, affinity data, frequency data, and/or other data relating to peptide screens—see e.g., data store 907a), information relating to context-specific, field based amino acid substitution matrices (including libraries thereof and sub-matrices derived therefrom—see e.g., data store 907b) and/or other data stores. In some implementations, the various databases of system 900 may be supported by or run on one or more database servers such as, for example one or more database servers 913.

One or more interfacing components 909a-909n may include additional modules, applications, data stores, websites, input devices, and/or other components wherein information can be exchanged therewith for using a library of field based amino acid substitution matrices to optimize an iterative peptide screen.

In some implementations, the invention also provides methods and systems for using a known binding/non-binding peptide sequence distribution and the library of context-specific, molecular field-based amino acid substitution matrices to identify a population of 3D binding pharmacophores for a binding target. Whilst peptides are very useful for screening applications, they typically make poor drugs as they are too large to migrate across the body's cellular membranes and can easily be degraded both inside and outside of the body. Once having identified a set of peptides that bind to a target from the screening processes, it is therefore necessary to understand their 3D bioactive binding conformations in order to be able to search small molecule databases for more drug-like molecules that can present the same 3D configuration of fields and are therefore likely to have the same biological activity and properties. These small molecule drug candidates can be discovered using a field-based virtual screening program that searches using a consensus field pharmacophore derived from the binding peptides resulting from analysis of the output of a screening process such as those described herein.

The generation of a consensus binding pharmacophore is designed to identify the 3D bioactive conformation of a set of binding peptides (or a single binding peptide) directly from the binding peptide sequences without the need to resort to the solution of a complexed or co-crystallized structure of the peptide bound into the target. This structure determination by X-ray crystallography or nuclear magnetic resonance (NMR) may be impossible (due to the target being membrane associated or being too large for NMR determination) or may be simply be too time-consuming and expensive to perform regularly. This is particularly true when multiple (often over one hundred) binding peptides need to be considered for a single target, as would routinely be the case in the results of a peptide screening exercise.

Generating an accurate 3D bioactive conformation is critical as the field points for the consensus binding peptide in this conformation provide the template of the pharmacophore that is used as the search in a small molecule virtual screening run. In the context of peptide screening, often there is a resultant population of binding peptides, each of which will have one or more predicted bioactive conformations generated therefor. Analysis of the population of these conformations and the variations across the amino acids will be used along with direct experimental information obtained from amino acid substitution scanning (repetitive replacement of successive amino acids in the binding peptides with each of the other 19 amino acids followed by activity testing) and binding affinity studies.

FIG. 13 illustrates a process 1300, which is an example of a process for using a known binding peptide sequence distribution and a library of context-specific, molecular field-based amino acid substitution matrices to identify a population of binding pharmacophores for a binding target. Process 1300 can be used to generate one or more predicted binding conformations for peptide sequences that are known to bind to the target in the screen. The method can be used with non-standard and modified amino acids as well as the standard set of 20 naturally occurring amino acids.

In some implementations, process 1300 includes an operation 1301, wherein sequences of the binding (and in some implementations non-binding and partially binding) peptides from a peptide screen are aligned (e.g., similar to the alignment of operations 809-811 of process 800). In some implementations, a “seqAlign” sequence alignment module 1411b of system 1400 may be used to or assist in operation 1301. If an enriched, iterative screening process such as, for example, process 800, is used, the identified peptides may be selected after a final round of screening that is presumed to provide the most desirable set of binding peptide sequences. In an operation 1303, a binding motif of binding sequences from peptide screen may be identified (i.e., similar to the binding motif identification of operation 811 of process 800). In some implementations, a “findMotif” motif identification module 1411a of system 1400 may be used to or assist in operation 1303. In some implementations, the aligned peptide sequences may be used as the alignment used for subsequent steps in process 1300 (e.g., from which a position is selected, etc.). However, in some implementations, an identified motif from the peptide sequences may itself be aligned and used as the alignment for subsequent steps in the process.

In an operation 1305, one position of the alignment is selected. (e.g., a user may select the position of the alignment from a GUI presented by received at a computer-implemented system for identifying a population of binding pharmacophores for a binding target.; e.g., a GUI provided by one or more modules 1411a-1411n of system 1400 illustrated in FIG. 14). This selection may be automated (e.g., based on one or more factors) or made/entered manually. In some implementations, as process 1300 iteratively cycles, all positions of an alignment may eventually be selected. In some implementations, only some positions may be selected.

In an operation 1307, a relative activity score for each of the 20 amino acids is calculated based on the observed population of that amino acid in the binding and/or non-binding peptide populations of the alignment at the selected sequence position. This calculation may be the same as or similar to the calculation of relative activity scores as described with respect to process 800. For example, in the alignment shown in Table 2 above there are five sequences, each with a binding score. At position 4, there are five amino acids, three of which are ARG (R) and two of which are THR (T). The ARGs appear in peptides that consistently have a higher binding affinity (0.98, 0.85 and 0.87) than those containing THRs (0.34 and 0.42) at that position. The relative activity score for R in this case would be higher (average=0.9) than T (average=0.38). Each of the 20 amino acids (assuming each of them occurs at the selected position) can thus be assigned a relative activity score for the selected position of the peptide. In some implementations, these calculations may be performed by a computer implemented system for generation of a consensus field pharmacophore (e.g., by a “calcRAS” activity score calculation module 1411c of system 1400).

In an operation 1309, the amino acid relativity scores can be normalized and/or weighted. In some implementations, the normalization and/or weighting may be performed by a computer implemented system for generation of a consensus field pharmacophore (e.g., by the “calcRAS” activity score calculation module 1411c of system 1400). Normalization may be performed in a number of ways such as, for example, using log-odds methods which express the scores in terms of the probabilities of transformation of one amino acid into another. In some cases, it may be desirable to weight the relative activity scores to better account for the known contribution of a given amino acid to the overall binding of the peptide as determined by amino acid substitution scanning. This maximizes the relative contribution of important positions in the binding motif. In other cases, for example with a very conserved sequence profile at one position, it may be beneficial to weight and/or normalize the scores such that the range of the observed scores for certain amino acid types is increased or decreased to allow for better discrimination of other potential binding sequences.

Weighting of the relative activity scores for an amino acid at the selected position may use knowledge of the amino acid's frequency of occurrence at the selected position in binding/non-binding peptides. For example, the more frequently an amino acid occurs in the population of aligned peptides, the more heavily that amino acid may be weighted. In some implementations, the weighting may utilize direct experimental information measuring the binding affinity of the specific peptide sequences. In some implementations, the weighting may utilize information obtained from amino acid substitution scanning (repetitive replacement of successive amino acids followed by activity testing) in which those amino acids occur at the selected position. In some implementations, multiple weighting methods may be used together (including those discussed above). In any instance, use of a weighting technique on the calculated relative activity scores may be used so as to take into account different factors/realities relating to known information from a binding screen or the peptides thereof so as to more intelligently reflect the affect that a given amino acid may have on binding.

In an operation 1311, an observed distance matrix is calculated by pairwise comparison of the relative activity scores of each of the 20 amino acids with each of the others. In some implementations, this calculation may be performed by a computer implemented system for generation of a consensus field pharmacophore (e.g., one or more modules 1411a-1411n of system 1400). As discussed above with respect to process 800, in the case of a matrix generated using just naturally occurring amino acids, this will result in a symmetrical 20×20 observed distance matrix (often times, and typically after an initial screening run, all 20 will be present at the selected position at least once; if not all 20 amino acids are present at the selected position, it may be given a relative activity score of 0; ensuring a 20×20 matrix). The comparison may include generating a measure of the difference or similarity between the two relative activity scores of each amino acid (as described herein, in some instances these scores may have been normalized and/or weighted). Difference/distance matrices and similarity matrices are closely related, with high values indicating dissimilarity in a distance matrix, but similarity in similarity matrix. For a given pair, the corresponding cell's value (X) in a distance matrix would be 1-X in a similarity matrix. In some implementations, the process described herein uses both distance and similarity matrices based on the same underlying pairwise similarity scores. The comparison may include calculating a ratio of the compared relative activity scores (wherein an amino acid compared against itself yields a similarity of 1) or may reflect the mathematical difference between the two relative activity scores (e.g., if relative activity scores range from 0 to +1, then the differences can range from 0 to +1). A variety of other distance metrics may also be used including simple Euclidean (root mean squared) distance, weighted distance, log-odds and other methods. The resultant observed distance matrix will be symmetrical and have identical diagonal values (due to the occurrence of amino acids being compared to themselves), therefore resulting in a matrix containing 190 meaningful pairwise similarity values (for a 20×20 matrix). The values contained in matrix may be scaled beyond a 0 to +1 distribution by the methods described above. In this, it is identical in form to the matrix described in FIG. 6.

In some implementations, the generation of the observed distance matrix may be performed by a computer implemented system for iterative library enrichment (e.g., by the “calcOMat” matrix calculation module 1411d of system 1400).

In an operation 1313, this observed distance matrix is compared against sub-matrices in a context-specific, molecular field-based amino acid substitution matrix library (e.g., a library comprising substitution matrices generated using a process such as for example, process 300). In some implementations, the observed distances matrix may be compared against all of the sub-matrices in the library.

In some implementations, the observed distance matrix may be compared against a subset of all of the sub-matrices in the library. The comparison of the observed distance matrix is performed against the sub-matrices because the sub-matrices will be of the same shape (likely 20×20) as the observed distance matrix. The alignment and activity score calculations do not take rotamers into account, therefore the observed distance matrix is also likely a 20×20 matrix unless non-naturally occurring amino acids are included. In some implementations, these comparisons may be performed by a computer implemented system for generation of a consensus field pharmacophore (e.g., by a “scoreMat” matrix comparison module 1411e of system 1400).

As discussed above, in order for this comparison to be performed exhaustively, all of the sub-matrices contained in each of the field-based substitution matrices must be generated (as shown in 1110 in FIG. 11) via permutation/decomposition of data in the larger matrix and compared separately. In some implementations, this sub-matrix generation may be performed by a computer implemented system for generation of a consensus field pharmacophore (e.g., by a “genSubMat” sub-matrix generation module 1411f of system 1400—the generated sub-matrices may be stored in matrix library 1407b).

The comparison between the observed distance matrix and the generated sub-matrices can then be performed (e.g., by the “scoreMat” matrix comparison module 1411e of system 1400. Various methods may be used for this comparison such as, for example, array matching, vector matching, wavelet analysis, linear algebra, and other techniques known to those having skill in the art. In one implementation, a vector-based comparison is made between a vector calculated from the observed distance matrix and the vectors calculated from each of the sub-matrices in a library of context-based, molecular field based amino acid substitution matrices (e.g., the library matrices generated using a process such as process 300) using one or more metrics including dot product and/or maximum deviation metrics. n dimensional vectors representing the pairwise scores in two compared matrices can be compared by calculating the dot product between the vectors using the formula below (where n=190 for a 20×20 matrix) to evaluate the similarity between whole substitution matrices:

$$a \cdot b = {\sum }_{i = 1}^{190} {a}_{i} {b}_{i}$$

This dot product provides a single score that represents the overall pairwise similarity of two matrices. It may not necessarily elucidate the detail of how homogenously the deviations in this overall similarity are distributed. More detailed levels of pairwise matrix comparison can also be examined using other methods.

As discussed herein, in some implementations, the use of GPUs and/or GPU associated computing techniques may be used to accelerate the comparison of the observed sequence matrix against the various sub-matrices generated by permutation/decomposition of the field-based substitution matrices. Accordingly, in some implementations, a plurality (e.g., on the order of hundreds) of GPUs for may be used to perform these comparisons (see e.g., GPUs 1415 of system 1400).

In an operation 1315, a definable size set of the most similar matrices is selected as the matrices that most closely match the sequence distribution observed for that position in the peptide alignment. In some implementations, these selections may be performed by a computer implemented system for generation of a consensus field pharmacophore (e.g., by a selection module 1411g of system 1400). These selected matrices are the “preferred” matrices whose internal pattern of variance across the amino acids relative to each other most closely matches the pattern of sequence distribution observed for the selected. position in the peptide or binding motif alignment. This sequence distribution (and the relative activity scores that are calculated from it, contained in the observed distance matrix) is a direct biological measurement of the preferred amino acids in the binding peptides at that position in the binding sequence/motif. By indentifying the sub-matrices where the pattern of variability in the amino acids' fields most closely matches the observed pattern of variability in the amino acids' contribution to binding, the most likely structural and sequence context of that amino acid position in the binding peptide can be identified, as the description of these contexts is explicitly stored as part of the matrix and sub-matrix descriptions. In some implementations, one or more thresholds may be set (e.g., by an administrator or intelligently selected in an automated fashion) so that sub-matrices that are as similar or more similar to the threshold may be considered “preferred.” The threshold may be set by numerical limit (e.g., similarity>0.96 or by categorical value (e.g., top 10 most similar sub-matrices).

In an operation 1317, the backbone conformation, sidechain conformation (the specific amino acid rotamer), charge and ionization state, and/or other characteristics of the amino acids present at the selected position of the alignment is determined from contextual information stored with and describing the preferred sub-matrices. Selections of the preferred sub-matrices for each position in the peptide alignment (or binding sub-motif) are determined by serial analysis of each position in turn. When a given preferred sub-matrix is selected (as it matches the observed amino acid substitution potential variance most accurately), this information is used to look up the various sequence, conformational, charge and others characteristics of the residue at the selected position and its local environment. This is possible because this information is explicitly encoded in the description of the full matrix (which describes the properties of the residues in the surrounding invariant peptide environment) and the sub-matrix (which describes the preferred rotamer conformation of the variable amino acid). From this data it is possible to reconstruct sufficient structural information to specify the full 3D structure preferred at a given position of the binding peptide sequence (or binding sub-motif). In some implementations, this determination may be performed by a computer implemented system for generation of a consensus field pharmacophore (e.g., by selection module 1411g of system 1400). In this manner, a set of preferred backbone conformations, rotamers, and charge and ionization states may be determined for use at the selected position.

In an operation 1319, in some implementations (e.g., if amino acid scanning information is available), the number of preferred conformation variants that are reconstructed for a given position in the binding peptide sequence (or binding sub-motif thereof) may be varied to preferentially sample conformational space around residues that are thought to be involved directly in the binding of the peptide to the target. Whereas a single amino acid variant (consisting of a specific set of sequence, backbone conformation, sidechain conformation, charge and ionization state and other parameters), representing the parameters encoded by the most similar preferred matrix/sub-matrix combination may be sufficient to represent a ‘non-binding’ amino acid position, we may choose to include more variants at positions known to be involved in binding. This is because the ‘non-binding’ position are not forming direct interactions with the target protein and are therefore acting only to hold the larger peptide structure together and in the correct conformation. These positions can be considered to have minimal or no information content describing the impact on the strength and specificity of the binding interaction, and will therefore not contribute directly to the ultimate field pharmacophore for the binders. As such any one (preferably the best/most similar) conformation at these positions will perform adequately, and it reduces computational complexity to use just a single conformation. Residues in the binding positions are however correlated with (and therefore contain useful information about) the strength and specificity of binding. By creating multiple peptide structures that incorporate different combinations of parameters that are associated with the best binders, we can sample and analyze a range of binding space to understand the combinations of contributions that various portions of the fields across the binding peptides make to that binding. This will ultimately result in the creation of a larger number of 3D peptide structures where the additional variants are focused on permutations of amino acids and their rotamers known to be closely involved in binding. Ultimately by calculating and comparing the fields around this ensemble of 3D structures it is possible to identify one or more clusters of similar field patterns that represent different binding modes for those peptides. The consensus pattern of fields for one or more of those clusters then becomes the pharmacophore for the binding peptide that is used as a probe in the virtual screening operation.

Process 1300 then returns to operation 1305, wherein the subsequent position on the selected peptide/motif alignment is chosen and operations 1305 through 1319 are performed until all the peptide/motif sequence alignment has been analyzed (or a desired subset thereof).

In an operation 1321, a population of 3D peptide structures is generated using the identified sequence, backbone, rotamer, and charge and ionization state information at each position of the alignment. This may be done by sequentially generating peptides having every possible combination of sequence, backbone, rotamer, and charge and ionization state combinations identified in operation 1315. As each position likely includes multiple preferred backbone, rotamer and charge state characteristics, a large number of peptide structures may be generated. This number will be reduced due to limitations vis a vis clashes between rotamers, backbone conformations and charge state combinations. The 3D structures may be constructed using the processes and tools used above in process 300. For example, construction of each 3D peptide structure may include first trimming a reference backbone-only structure (consisting of just N-C_{A}-C-O atoms) to the correct (i.e., specified) sequence length. The correct (i.e., specified) sequence of amino acid sidechains is then attached to this reference backbone by calculating the difference between the vectors formed respectively by the N-C_{A} C_{B} bonds of the backbone and sidechain rotamer amino acids and using the rotation matrix generated to overlay the N, C_{A} and C_{B} atoms of the backbone and sidechain amino acids. The same rotation matrix is also applied to the remaining sidechain atoms of the rotamer, effectively attaching its atoms in their correct conformation to the backbone. Each sidechain to be attached is selected from the rotamer library for that amino acid in a specific rotamer conformation. Finally, the backbone phi, psi and omega angles are set by torsional rotations to their specified values. The charge and ionization state of the amino acids in the peptides will have been automatically set by the selection of the specified rotamers. In some implementations, these structures may be generated by a computer implemented system for generation of a consensus field pharmacophore (e.g., a “subpep” 3D structure generation module 1411h of system 1400 that is the same as or similar to 3D structure generation module 711a of system 700).

In an operation 1323, conformations with steric clashes are detected and discarded or may be subject to a constrained energy minimization run. In this technique the atoms of the molecule are moved in small directed increments away from areas of high energy interactions (i.e. steric clashes) into more acceptable positions. This simulates the relaxation of a molecule into a lower energy state. In some implementations, this operation may be assisted or performed by a computer implemented system for generation of a consensus field pharmacophore (e.g., by a steric clash detection module 1411i of system 1400).

In an operation 1325, molecular fields and field points are then generated for each 3D peptide structure. This may be done in the same or similar way as described above with respect to process 300. For example, generation of fields may include applying a force field program/field calculation tool (e.g., a “xedconvert” field calculation/force field tool 1409a of system 1400 that is the same as or similar to the force field/field calculation tool 709 of system 700) that calculates the molecular electrostatic potential across the surface of the variant molecules. In some implementations, the force field module may create a contour map around a generated 3D molecular structure at a van der Waals radius distance for one or more of 4 fields ([1] the positive electrostatic field of the molecule's surface; [2] the negative electrostatic field of the molecule's surface; [3]: the steric (shape/stickiness) properties of the molecule's surface; and [4] hydrophobic properties of the molecule's surface in its bioactive conformation). An example of this type of force field/field calculation tool includes the XED™ force field tools offered by Cresset Biomolecular Discovery Ltd (see also e.g., U.S. Pat. No. 7,805,257, which is hereby incorporated by reference herein in its entirety).

In an operation 1327, a consensus field pharmacophore may be generated by aligning and clustering the resulting peptide structures' field information (e.g., whole fields or field points) in an operation known as ‘templating’. Templating allows the identification of consensus patterns of binding (pharmacophores) from amongst the generated peptide structures. This templating operation clusters the fields or field points associated with various molecules to identify the sets of fields or field points for all molecules that exhibit the minimum overall variation across the putative structures of the binding peptides. Field points that are closely conserved between the set of peptide structures are most likely to be those that are most directly involved in binding as these explain best the similarity between the molecules in terms of their likely biological activity and properties. These points will be incorporated into the consensus pharmacophore. If the fields of one or more molecules in a specific conformation cannot be matched to those of a larger series of other molecules that align amongst themselves, it is likely that those molecule/s exist in a different conformation, perhaps because they have a different binding mode (they are binding in a different position to the target). In some implementations, this operation may be performed by a computer implemented system for generation of a consensus field pharmacophore (e.g., a “fieldTemplater” field templating module 1411j of system 1400).

In an operation 1329 this consensus pharmacophore may be used as input for a search for small molecule drug candidates being capable of presenting a similar pattern of field points under physiologically accessible conditions that match that of the generated consensus field pharmacophore.

FIG. 14 illustrates a system 1400, which is an example of a system for generating a consensus field pharmacophore. In some implementations, system 1400 includes a control application 1401, one or more computing devices 1403a-1403n, at least one input device 1405, one or more data stores 1407a-1407n, one or more interfacing components/systems 1409a-1409n, and/or other elements. The features and functions for generating a consensus field pharmacophore (e.g., process 1300) may be enabled by systems such as system 1400.

In some implementations, control application 1401 may be or include one or more computer applications that operate on or across one or more computing devices 1403a-1403n. Control application 1401 may be a software application that instructs one or more processors of one or more computing devices 1403a-1403n to perform one or more of the consensus pharmacophore generation functions (or other functions) described herein. In some embodiments, control application 1401 may include one or more modules 1411a-1411n that may comprise instructions for using generate a consensus pharmacophore (or other functions) described herein such as, for example, receipt and analysis of peptide screen results; alignment of peptides from a screening run; selection of a position from a peptide alignment; calculation of relative activity scores; normalization/weighting of relative activity scores; calculation of observed distance matrices; generation of sub-matrices from whole context-specific field-based amino acid substitution matrices; comparison of observed distance matrices against context-specific field based amino acid substitution matrices and/or sub-matrices thereof (including using GPUs 1415 for this operation); selection of preferred matrices, selection of preferred backbone conformations, rotamer conformations, charge states; formulation of 3D peptide models using preferred backbone/conformer/charge/ionization state information; generation of field information for the 3D models; templating to arrive at a consensus field pharmacophore; and/or other features and functions. Other modules, including those of other applications/programs may be used or may interface with control application 1401 and/or one or more of modules 1411a-1411n.

One or more computing devices 1403a-1403n may be one or more servers, personal computers, or other computing devices having one or more processors, (including, for example, microprocessors 1417 and/or GPUs 1415), memory devices, and/or other computer elements enabling performance of the features and functions described herein. In some implementations, one or more of control application 1401 and modules 1411a-1411n may be distributed among a plurality of computing devices 1403a-1403n. In some implementations, computing devices 1403a-1403n maybe geographically distributed and therefore may be connected via one or more computer networks (e.g., a local area network, a wide area network, the Internet, an intranet, etc.).

At least one input device 1405 may be or include a computing device that supports various hardware devices (e.g., keyboards, mouse, touch screen, display screen, and/or other hardware devices) and software components (e.g., graphical user interfaces) for enabling receipt of information from (and presentation of information to) a user to control application 1401 and/or other components of system 1400. In some implementations, input device 1405 may be part of or otherwise supported by one or more of computing devices 1403a-1403n. In some implementations, a computing device supporting input device 1405 may be connected to one or more of computing devices 1403a-1403n (e.g., via a wireline connection, wireless connection, over a network, etc.).

One or more data stores 1407a-1407n may be or include relational databases, non-relational databases, directories, or other data storage mechanisms for storing data used in consensus field pharmacophore generation. For example, one or more data stores 1407a-1407n may include stores of information relating to peptide screening data (including peptide sequences, affinity data, frequency data, and/or other data relating to peptide screens—see e.g., data store 1407a), information relating to context-specific, field based amino acid substitution matrices (including libraries thereof and sub-matrices derived therefrom—see e.g., data store 1407b) and/or other data stores. In some implementations, the various databases of system 1400 may be supported by or run on one or more data base servers such as, for example one or more database servers 1413.

One or more interfacing components 1409a-1409n may include additional modules, applications, data stores, websites, input devices, and/or other components wherein information can be exchanged therewith for using a library of field based amino acid substitution matrices to optimize an iterative peptide screen.

While illustrated in separate figures, the systems described herein for constructing context-specific, field-based amino acid substitution matrices (e.g., system 700), iterative peptide screen refinement (e.g., system 900 of FIG. 9), and field pharmacophore construction and small molecule discovery (e.g., system 1400 of FIG. 14), may be modified, combined and/or used together as would be appreciated by those having skill in the art to provide a system for performing the features and functions of the various processes described herein together in a single system.

In some implementations, the invention may include computer-readable media for having computer-executable instructions thereon that when executed cause one or more processors (e.g., processors 715, 717, 915, 917, 1415, 1417) to perform some or all of the features and functions relating to matrix generation, library enrichment, pharmacophore generation, and/or other features and functions herein. For example, the systems described herein may include hard disks, magnetic media, digital media, volatile and non-volatile media, removable discs or other removable media, having instructions thereon for performing the aforementioned features and functions.

Those having skill in the art will appreciate that the invention described herein may work with various system configurations. Accordingly, more or less of the aforementioned system components described herein may be used and/or combined in various embodiments. It should also be understood that various software modules that provided as examples for performing certain features and functions described herein may be maintained on components other than those illustrated in the various figures described herein, as necessary or desired. In some implementations, as would be appreciated, the functionalities described herein may be implemented in various combinations of hardware and/or firmware, in addition to, or instead of, software.

The various processes illustrated herein have been provided as examples only. The order of operations of the various processes/methods described herein may be varied from the order discussed herein. In some implementations, additional operations may be performed. In some implementations, certain operations may be omitted.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of any associated claims.

What is claimed is:

1. A method for identification of structural characteristics of binding peptide sequences, the method comprising:
receiving screening data relating to a plurality of peptides used in a peptide screen against a target molecule, the screening data including sequence information and one or more of binding affinity or activity information for the plurality of peptides;
constructing a sequence alignment using least a subset of the plurality of peptides;
for each of a plurality of positions of the sequence alignment:
selecting a position of the sequence alignment,
constructing an observed distance matrix describing a distance between the relative binding activities of pairwise comparisons of each amino acid at the selected position,
comparing the observed distance matrix to a plurality of field-based amino acid substitution matrices having the same shape as the observed distance matrix,
identifying one or more preferred field-based amino acid substitution matrices from the plurality of field-based amino acid substitution matrices based on the comparison, and
identifying a plurality of characteristics for the selected position using the preferred field-based amino acid substitution matrices;
generating a plurality of three-dimensional peptide structures using the plurality of characteristics for each of the plurality of positions of the sequence alignment;
generating molecular field information for at least a subset of the plurality of three-dimensional peptide structures; and
determining a consensus field pharmacophore using the generated molecular field information.

2. The method of claim 1, wherein constructing a sequence alignment includes:
aligning at least a subset of the plurality of peptides;
identifying a binding motif from the aligned peptides; and
constructing the sequence alignment using a plurality of occurrences of the binding motif.

3. The method of claim 1, wherein constructing the sequence alignment includes aligning at least a subset of the plurality of peptides to form the sequence alignment.

4. The method of claim 1, wherein the plurality of characteristics include one or more of backbone conformation, rotamer conformation, charge state, or ionization state.

5. The method of claim 4, wherein generating a plurality of three-dimensional peptide structures includes generating a three-dimensional peptide structure for permutations of the plurality of characteristics.

6. The method of claim 1, wherein the at least a subset of the plurality of three-dimensional peptide structures does not include three-dimensional peptide structures with steric clashes.

7. The method of claim 1, wherein constructing an observed distance matrix comprises:
calculating relative activity scores for each of the amino acids present in the sequence alignment at the selected position;
performing a pairwise comparison of each of the calculated relative activity scores;
calculating a distance score for each comparison based on the distance between compared scores; and
assembling the distance scores into the observed distance matrix.

8. The method of claim 1, wherein the plurality of field-based amino acid substitution matrices comprise sub-matrices created from a larger field-based amino acid substitution matrix.

9. The method of claim 6, wherein identifying one or more preferred field-based amino acid substitution matrices comprises identifying one or more of the sub-matrices that are most similar to the observed distance matrix.

10. A system for identification of structural characteristics of binding peptide sequences, the system comprising:
one or more processors configured to:
receive screening data relating to a plurality of peptides used in a peptide screen against a target molecule, the screening data including sequence information and one or more of binding affinity or activity information for the plurality of peptides;
construct a sequence alignment using least a subset of the plurality of peptides;
for each of a plurality of positions of the sequence alignment:
select a position of the sequence alignment,
construct an observed distance matrix describing a distance between the relative binding activities of pairwise comparisons of each amino acid at the selected position,
compare the observed distance matrix to a plurality of field-based amino acid substitution matrices having the same shape as the observed distance matrix,
identify one or more preferred field-based amino acid substitution matrices from the plurality of field-based amino acid substitution matrices based on the comparison, and
identify a plurality of characteristics for the selected position using the preferred field-based amino acid substitution matrices;
generate a plurality of three-dimensional peptide structures using the plurality of characteristics for each of the plurality of positions of the sequence alignment;
generate molecular field information for at least a subset of the plurality of three-dimensional peptide structures; and
determine a consensus field pharmacophore using the generated molecular field information.

11. The system of claim 10, wherein the one or more processors configured to construct a sequence alignment are further configured to:
align at least a subset of the plurality of peptides;
identify a binding motif from the aligned peptides; and
construct the sequence alignment using a plurality of occurrences of the binding motif.

12. The system of claim 10, wherein the one or more processors configured to construct a sequence alignment are further configured to align at least a subset of the plurality of peptides to form the sequence alignment.

13. The system of claim 11, wherein the plurality of characteristics include one or more of backbone conformation, rotamer conformation, charge state, or ionization state.

14. The system of claim 13, wherein the one or more processors configured to generate a plurality of three-dimensional peptide structures are further configured to generate a three-dimensional peptide structure for permutations of the plurality of characteristics.

15. The system of claim 10, wherein the at least a subset of the plurality of three-dimensional peptide structures does not include three-dimensional peptide structures with steric clashes.

16. The system of claim 10, wherein the one or more processors configured to construct an observed distance matrix are further configured to:
calculate relative activity scores for each of the amino acids present in the sequence alignment at the selected position;
perform a pairwise comparison of each of the calculated relative activity scores;
calculate a distance score for each comparison based on the distance between compared scores; and
assemble the distance scores into the observed distance matrix.

17. The system of claim 10, wherein the plurality of field-based amino acid substitution matrices comprise sub-matrices created from a larger field-based amino acid substitution matrix.

18. The system of claim 17, wherein the one or more processors configured to identify one or more preferred field-based amino acid substitution matrices are further configured to identify one or more of the sub-matrices that are most similar to the observed distance matrix.

19. A computer-readable medium having computer-executable instructions thereon that when executed by one or more processors cause the one or more processors to perform a plurality of operations comprising:
receiving screening data relating to a plurality of peptides used in a peptide screen against a target molecule, the screening data including sequence information and one or more of binding affinity or activity information for the plurality of peptides;
constructing a sequence alignment using least a subset of the plurality of peptides;
for each of a plurality of positions of the sequence alignment:
selecting a position of the sequence alignment,
constructing an observed distance matrix describing a distance between the relative binding activities of pairwise comparisons of each amino acid at the selected position,
comparing the observed distance matrix to a plurality of field-based amino acid substitution matrices having the same shape as the observed distance matrix,
identifying one or more preferred field-based amino acid substitution matrices from the plurality of field-based amino acid substitution matrices based on the comparison, and
identifying a plurality of characteristics for the selected position using the preferred field-based amino acid substitution matrices;
generating a plurality of three-dimensional peptide structures using the plurality of characteristics for each of the plurality of positions of the sequence alignment;
generating molecular field information for at least a subset of the plurality of three-dimensional peptide structures; and
determining a consensus field pharmacophore using the generated molecular field information.

20. The computer-readable medium of claim 19, wherein constructing a sequence alignment includes:
aligning at least a subset of the plurality of peptides;
identifying a binding motif from the aligned peptides; and
constructing the sequence alignment using a plurality of occurrences of the binding motif.

21. The computer-readable medium of claim 19, wherein constructing the sequence alignment includes aligning at least a subset of the plurality of peptides to form the sequence alignment.

22. The computer-readable medium of claim 19, wherein the plurality of characteristics include one or more of backbone conformation, rotamer conformation, charge state, or ionization state.

23. The computer-readable medium of claim 22, wherein generating a plurality of three-dimensional peptide structures includes generating a three-dimensional peptide structure for permutations of the plurality of characteristics.

24. The computer-readable medium of claim 19, wherein the at least a subset of the plurality of three-dimensional peptide structures does not include three-dimensional peptide structures with steric clashes.

25. The computer-readable medium of claim 19, wherein constructing an observed distance matrix comprises:
calculating relative activity scores for each of the amino acids present in the sequence alignment at the selected position;
performing a pairwise comparison of each of the calculated relative activity scores;
calculating a distance score for each comparison based on the distance between compared scores; and
assembling the distance scores into the observed distance matrix.

26. The computer-readable medium of claim 19, wherein the plurality of field-based amino acid substitution matrices comprise sub-matrices created from a larger field-based amino acid substitution matrix.

27. The computer-readable medium of claim 26, wherein identifying one or more preferred field-based amino acid substitution matrices comprises identifying one or more of the sub-matrices that are most similar to the observed distance matrix.
